(19) United States
(12) Patent Application Publication
(10) Pub. No.: US 2010/0115024 A1
(43) Pub. Date: May 6, 2010

(54) Internet Service System in Connection with a Contacted Website and a Method for the Same

(75) Inventor: Seung June Song, Seoul (KR)

Correspondence Address: BACHMAN & LAPOINTE, P.C., 900 CHAPEL STREET, SUITE 1201, NEW HAVEN, CT, 06510, US

(73) Assignee: SECHANG INSTRUMENTS CO., LTD., Seoul (KR)

(21) Appl. No.: 12/530,783

(22) PCT Filed: Mar. 13, 2008
(86) PCT No.: PCT/KR2008/001410

§ 371 Date: Sep. 10, 2009

(30) Foreign Application Priority Data
Mar. 15, 2007 (KR) 10-2007-0025335
Jul. 20, 2007 (KR) 10-2007-0072877
Feb. 29, 2008 (KR) 10-2008-0018934

(51) Int. Cl. G06F 15/16

(52) U.S. Cl. 709/203; 709/217

(57) ABSTRACT

When user computer (50a, 50b, . . . , 50n) contacts a website (10a, 10b, . . . , 10n), the user computer transfers the URL of the website to an Internet service server (100). The Internet service server (100) provides an Internet service on particular position on the web page of the website displayed on the user computer such as bulletin board service, help contents service, demand service, advertisement service, electronic commerce service, ASP, game, chatting and message transmission.

### FIELD OF THE INVENTION

The present invention relates to an Internet service system in connection with an accessed website and a method for the same. The present invention make it possible for users who contact a website to be provided an Internet service beyond the services provided by the contacted website in connection with positions on web pages of the website.

### BACKGROUND

At present, the use of the website is subordinated to the Internet services provided by the contacted website and the use beyond them is impossible. However, it may be necessary for the users who contact the website to use more services beyond the services provided by the contacted website.

For example, in a website for electronic commerce such as a shopping mall, it is desirable if information related to selling products are provided and users can put the information on the website and exchange them each other. Even if the website does not provide such a service, it is desirable if the users who contact the website can actively put the relevant information on the web pages and exchange them. In this case, although the website provides the service, if another service is possible independent of the website, it is also desirable because users can obtain more objective information.

Specially, it is more desirable if such service is provided in connection with particular positions on web pages of the website. For example, in the website such as the shopping mall, if the information is provided at position on which a particular product is exhibited, the users can immediately recognize that the information is related to the product at the position.

In this case, opinions may be different according to age, hobby, personality, gender, occupation, language and nationality and it is desirable if a user can communicate with other user who is of the same group via, for example, message transmission.

Further, it is desirable if a help contents service which helps users for using the contacted website is provided independent of the service provided by the contacted website because it increases convenience to use the website.

Furthermore, it is desirable if a demand service which enables a user to demand or suggest an improvement is provided because the manager of the website can get what the user wants.

In another aspect, services which a website can provide is limited, however, users contacting the website may want more services so that it is desirable if such a want is satisfied.

For example, in an Internet book store site, a user may want a chatting service or short message service to ask other's opinion about a book displayed thereon. In this case, it is desirable if the service is possible to the user even if the Internet book store site does not provides the chatting service or short message service.

In another aspect, Internet services provided by a website is various from member management and bulletin board to chatting, game and message transmission. However, it may be inefficient if the website produces all the service programs and installs them on its server. That is, it is desirable if the website provides basic services and other services are provided to the users contacting the website from another source. In this case, it is more desirable if the other services are provided to the users contacting the website at particular positions of the web pages of the website.

Specially, it is furthermore desirable if the website provides basic contents and other services are provided to the users contacting the website by the users' choice.

For example, in an advertisement service exposed to the users, the website which the users contact does not provide the advertisement service, however, the advertisement to the users is possible in connection with particular positions on the web pages of the website. At this time, the users can make a choice to see contents only or contents with the advertisement.

Also, it is desirable if hardware appliance provided in the users' computers operates according to the websites which the users contact. Especially, in this case, it is more desirable if the service is customized according to each of the user or user computer and each hardware appliance in each of the computer operates according to the set up by the user and the websites which the user visits.

The hardware appliance is, for example, lighting, fan, air conditioner and boiler so on.

In controlling the hardware appliance according to the visited websites as described, it is furthermore desirable if the hardware appliance can be monitored or controlled by the visit of the website by a remote computer in connection with which the user wrote a profile for the operation of the hardware appliance and a remote control or home automation is easily accomplished.

As described, it is desirable if Internet services such as providing information, enabling users to put the information and exchange or more services beyond Internet service provided by the website which users contact are provided to the users contacting the website in connection with particular positions on the web pages of the website. Further more, it is more desirable if the Internet services are customized according to the user's taste. The present invention satisfies these demands.

### DISCLOSURE

### Technical Problem

The purpose of the present invention is to provide an Internet service necessary to a user in connection with particular positions on web pages of a website which a user computer contacts so that the user can use the Internet service freely and conveniently.

Especially, the present invention has a purpose to provide an Internet service which is not subordinated to and is beyond Internet service provided by the contacted website in connection with contents of the contacted website so that the efficiency of the Internet service is largely increased.

Further, the purpose of the present invention is to provide a remote control or home automation which enables a control of appliances in a remote location very easily and conveniently according to the website which the user computer contacts.

### Technical Solution

The present invention provides a method for providing Internet service in connection with URL which a user computer, which has a web browser, contacts where a server is connected to a plurality of the user computers via Internet and the server or a service server managed by the server has service data storage means which stores service data according to the Internet service in connection with the URL which the user computer contacts and position coordinate on web page according to the URL displayed on the user computer, comprising: website address transferring step wherein the user computer transfers the URL of the website to the server when the user computer contacts the website; website address recognition step wherein the server or the service server managed by the server reads the transferred URL; service interface output step wherein the server or the service server outputs service interface according to the Internet service on the web page of the website displayed on the user computer; and service data output step wherein the server or the service server outputs the service data on the position coordinate on the web page of the website displayed on the user computer in accordance with the service interface.

In this case the method may further comprise service data transferring step wherein the user computer transfers the service data with the position coordinate to the server or to the service server; service data storage step wherein the server or the service server stores the transferred service data on the service data storage means in connection with the position coordinate.

In this case, the service server may be the website which the user computer contacts.

In this case, the method may further comprise output position transferring step wherein the user computer transfers a particular position coordinate on the web page of the website displayed on the user computer to the server or the service server and the service data output step includes designated position output step wherein the server or the service server outputs the service data stored on the service data storage means in connection with the position coordinate transferred according to the output position transferring step on the position coordinate on the web page of the website displayed on the user computer.

In this case, the output position transferring step is to transfer the position coordinate pointed by a pointing device on the web page of the website displayed on the user computer.

In this case the service data output step includes service data presence step according to position wherein the server or the service sever displays the presence of the service data on the position coordinate on which the service data is present on the web page of the website displayed on the user computer; and service data output step according to designated position step wherein when position on which the presence of the service data is displayed is designated by the user computer, the server or the service server outputs the service data stored in connection with the designated position coordinate on the position coordinate on the web page of the website displayed on the user computer.

In this case, the service data presence step according to position may be to display the presence of the service data by figure. In this case, the service data presence step according to position may be to show the number of the service data at the figure. In this case, management authority for the Internet service may be given to a manager of the server or to a manager of the website which the user computer contacts.

In this case, the service data is classified by the character and stored by the classification on the service data storage means and the service data is outputted to the user computer according to the classification.

In this case, the method further comprises: service data input request step wherein the user computer let the server or the service server know that the service data is inputted in connection with designated position coordinate; and input means output step wherein the server or the service server outputs input means to the user computer according to the service data input request step; and the service data transferring step may be to transfer the data inputted to the input means to the server or the service server. In this case, the input means output step may be to output input form to the user computer.

In this case, the Internet service may be a bulletin board service and the service data storage means stores bulletin board contents. In this case, the Internet service maybe a help contents service which provides help contents for using the website which the user computer contacts and the service data storage means stores help contents.

In this case, the Internet service may be a demand service which demands or suggests improvement in connection with the website which the user computer contacts and the service data storage means stores demanded contents.

In this case, output of the demanded contents according to the service data output step may be made to a manager's computer of the server or a manager's computer of the website which the user computer contacts.

In this case, the Internet service may be an electronic commerce service and the service data storage means stores information related to the electronic commerce.

In this case, the Internet service may be an advertisement service and the service data storage means stores advertisement information.

In this case, the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

In this case, the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

In this case, the method further comprises area data size transferring step wherein the user computer captures an area around a position and calculates the data size and transfers the size of the data with the position coordinate to the server or the service server; area data size storage step wherein the server or the service server stores the data size in connection with the position coordinate; and renewal determination step wherein the server or the service server compares the data size in connection with the position coordinate and determines that the web page is renewed at the position if the change of the data size is detected. In this case, distance from the position by a constant length to upper, bottom, right and left may define the area.

The present invention also provides a method for providing Internet service in connection with URL which a user computer, which has a web browser, contacts where a server is connected to a plurality of the user computers via Internet, comprising: website address transferring step wherein the user computer transfers the URL of the website to the server when the user computer contacts the website; website address recognition step wherein the server or the service server managed by the server reads the transferred URL; service interface output step wherein the server or the service server outputs service interface according to the Internet service on the web page of the website displayed on the user computer; output position transferring step wherein the user computer transfers a particular position coordinate on the web page of the website displayed on the user computer to the server or the service server; designated position output step wherein the server or the service server outputs the service data stored on the service data storage means in connection with the position coordinate transferred according to the output position transferring step on the position coordinate on the web page of the website displayed on the user computer.

The present invention further provides a method for providing Internet service in connection with URL which a user computer, which has a web browser, contacts where a server is connected to a plurality of the user computers via Internet, comprising: website address transferring step wherein the user computer transfers the URL of the website to the server when the user computer contacts the website; list of user computers contacting the same web site output step wherein the server or the service server managed by the server reads the transferred URL and outputs list of the user computers which contact the website to the user computers; Internet service provision between user computers step wherein when the user computer selects one from the listed user computers, the server or the service server relays the user computer and the selected user computer and provides the Internet service between them. In this case, the Internet service between the user computers may be one among chatting, game and message transmission.

In this case, the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

In this case, the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

The present invention, furthermore, provides a server system providing Internet service in connection with URL which a user computer, which has a web browser, contacts where a server is connected to a plurality of the user computers via Internet, comprising: service data storage means which stores service data according to the Internet service in connection with the URL which the user computer contacts and position coordinate on, web page according to the URL displayed on the user computer; website address recognition means which reads the URL of the website transferred from the user computer when the user computer contacts the website; service interface output means which outputs service interface according to the Internet service on the web page of the website displayed on the user computer; service data output means which outputs the service data on the position coordinate on the web page of the website displayed on the user computer in accordance with the service interface.

The present invention, furthermore, provides a server system providing Internet service in connection with URL which a user computer, which has a web browser, contacts where a server is connected to a plurality of the user computers via Internet, comprising: website address recognition means which reads the URL of the website transferred from the user computer when the user computer contacts the website; service interface output means which outputs service interface according to the Internet service on the web page of the website displayed on the user computer; designated position output means which outputs the service data on an output position coordinate on the web page of the website displayed on the user computer in response to the user computer's designation of the output position coordinate.

The present invention, furthermore, provides a server system providing Internet service in connection with URL which a user computer, which has a web browser, contacts where a server is connected to a plurality of the user computers via Internet, comprising: website address recognition means which reads the URL of the website transferred from the user computer when the user computer contacts the website; list of user computers contacting the same web site output means which outputs list of the user computers which contact the website according to the URL; Internet service provision between user computers means which relays the user computer and the selected user computer and provides the Internet service between them when the user computer selects one from the listed user computers.

In this case, the Internet service between the user computers is one among chatting, game and message transmission.

The present invention, furthermore, provides a method for providing Internet service in connection with URL which a user computer, which has a web browser, contacts where a server is connected to a plurality of the user computers via Internet; the server or a service server managed by the server stores position coordinate at which the Internet service is provided on the web page of the website displayed on the user computer in connection with the URL which the user computer contacts; and the user computer has an Internet service apparatus which reads the URL of the website which the user computer contacts and transfers the URL to the server, comprising: website address transferring step wherein the Internet service apparatus reads and transfers the URL of the website to the server when the user computer contacts the website; and Internet service provision step wherein the server or the service server reads the URL and provides the Internet service at the position coordinate corresponding to the URL on the web page of the website displayed on the user computer.

In this case, the website which the user computer contacts may have a web page file containing a call code to make the Internet service apparatus downloaded from the server or the service server. In this case, the call code is displayed on the position at which the Internet service is provided on the web page of the website displayed on the user computer.

In this case, the server or the service server stores key words in connection with the URL and the method further comprises search form output step wherein the server or the service server outputs search form to which the key word is inputted on the web page of the website displayed on the user computer; and search result output step wherein the server or the service server compares the inputted keyword through the search form with the key word stored in connection with the URL and outputs the result to the user computer. In this case, the server or the service server stores advertisement data and the method further comprising advertisement step wherein the server or the service server outputs the advertisement data on the web page of the website displayed on the user computer. In this case, the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

In this case, the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

The present invention, furthermore, provides a method for controlling hardware appliance provided in a user computer in connection with URL which the user computer which has a web browser contacts where a server is connected to a plurality of the user computers via Internet and the server or a service server managed by the server stores a unique value indicating the hardware appliance provided in the user computer in connection with the URL which the user computer contacts, comprising: website address transferring step wherein the user computer transfers the URL of the website to the server when the user computer contacts the website; control command request step wherein the user computer request a control command to control the hardware appliance to the server or the service server; and control command step wherein the server or the service server transfers a control code according to the URL to the user computer.

In this case, the unique value indicating the hardware appliance provided in the user computer may be IP address, Mac address and port number, to which the hardware appliance is connected, of the user computer.

In this case, it is preferable if the unique value indicating the hardware appliance provided in the user computer in connection with the URL is recorded with respect to each member of the user so that the hardware appliance is controlled in connection with the URL the user computer contacts according to the each member. The present invention, furthermore, provides a method performed by an Internet service apparatus provided in the user computer for providing Internet service in connection with URL which a user computer having a web browser contacts, the Internet service apparatus storing service data in connection with the URL and position coordinate on the web page of the URL displayed on the user computer, comprising: website address recognition step recognizing the URL of the website when the user computer contacts the website; service interface output step outputting service interface according to the Internet service on the web page of the website displayed on the user computer; and service data output step outputting the service data on the corresponding position coordinate on the web page of the website displayed on the user computer in accordance with the service interface.

In this case, the website may be a specified website and the Internet service apparatus is downloaded from the specified website and installed on the user computer.

In this case, the Internet service apparatus may be installed on a portable memory device and executed by auto run when the portable memory device is connected to the user computer.

In this case, the Internet service provided by the Internet service apparatus is a help contents service which outputs help contents for using the website on the corresponding position on the web page of the website which the user computer contacts.

In this case, the Internet service provided by the Internet service apparatus is an advertisement service which outputs the advertisement data on the corresponding position on the web page of the website which the user computer contacts.

The present invention, furthermore, provides a method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising: remote connection to the user computer step wherein a remote computer connects to the user computer by remote connection; website address transferring step wherein the user computer transfers the URL of the website to the server when the user computer contacts the website by the control of the remote computer; control command request step wherein the user computer request a control command to control the designated hardware appliance to the server or the service server by the control of the remote computer; and control command step wherein the server or the service server transfers a control code to the user computer. In this case, the control command request step may include designation of hardware appliance step wherein the user computer designates the hardware appliance provided therein to be controlled in response to request of the server or the service server to designate the hardware appliance.

In this case, the unique value indicating the hardware appliance provided in the user computer includes IP address, Mac address of the user computer and sub-value according to sub-connection to the hardware appliance.

In this case, the sub-value according to sub-connection to the hardware appliance maybe Mac address of a hardware interface device and slot ID in the hardware interface device.

In this case, the unique value indicating the hardware appliance provided in the user computer in connection with the URL is recorded with respect to each member of the user so that the hardware appliance is controlled in connection with the URL the user computer contacts according to the each member.

In this case, the user computer is communication terminal equipment which can communicate with the server or the service server and the website through Internet.

In this case, the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer. In this case, the hardware control interface is directed to set-up of the hardware appliance in connection with the URL, display of monitoring result of the hardware appliance and control command for the hardware appliance.

The present invention, furthermore, provides a method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising: website address transferring step wherein a remote computer at the remote location transfers the URL of the website to the server when the remote computer contacts the website; control command request step wherein the remote computer request a control command to control the designated hardware appliance provided in the user computer to the server or the service server; and control command step wherein the server or the service server transfers a control code to the user computer.

In this case, the control command request step includes designation of hardware appliance step wherein the remote computer designates the hardware appliance provided in the user computer to be controlled in response to request of the server or the service server to designate the hardware appliance.

In this case, it is preferable if the unique value indicating the hardware appliance provided in the user computer in connection with the URL is recorded with respect to each member of the user so that the hardware appliance is controlled in connection with the URL the remote computer contacts according to the each member. In this case, it is preferable if the user computer is communication terminal equipment which can communicate with the server or the service server and the website through Internet.

In this case, it is preferable if each control method of the hardware appliance is set up with respect to the respective member and if the remote computer selects another member's set up for the control method of the same hardware appliance, the server or the service server controls the user computer having the same hardware appliance according to the another's set up.

In this case, it is preferable if the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

In this case, the hardware control interface is directed to set-up of the hardware appliance in connection with the URL, display of monitoring result of the hardware appliance and control command for the hardware appliance.

The present invention, furthermore, provides a method for controlling hardware appliance provided in a user computer in connection with URL which the user computer which has a web browser contacts where a server is connected to a plurality of the user computers via Internet and the server or a service server managed by the server stores a unique value indicating the hardware appliance provided in the user computer in connection with the URL which the user computer contacts, comprising: website address recognition step wherein the server recognizes the URL of the website which the user computer contacts by the URL transferred from the user computer when the user computer contacts the website; and control command step wherein the server or the service server transfers a control code to control the hardware appliance provided therein to the user computer in response to the user computer's request for a control command to control the hardware appliance. The present invention, furthermore, provides a method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising: website address recognition step wherein the server recognizes the URL of the website which the user computer contacts by the URL transferred from the user computer when the user computer contacts the website by the control of the remote computer; and control command step wherein the server or the service server transfers a control code to the user computer to control the hardware appliance provided therein in response to the user computer's request for a control command to control the designated hardware appliance by the control of the remote computer.

In this case, the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

The present invention, furthermore, provides a method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising: website address recognition step wherein the server recognize URL of the website which a remote computer contacts by the URL transferred from the remote computer when the remote computer contacts the website; and control command step wherein the server or the service server transfers a control code to the user computer to control the hardware appliance provided therein in response to the remote computer's request for a control command to control the designated hardware appliance.

In this case, the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

### Advantegeous Effects

The present invention shows the Internet service system which provides a variety of Internet services in connection with the URL which the user computer contacts on the particular position on the web page displayed on the user computer and the method for the same.

The present invention provides the bulletin board service, the help contents service, the demand service, the advertisement service, the electronic commerce service, game, message transmission, chatting and a kind of ASP service on the related position of the web page of the website displayed on the user computer beyond the Internet service which the website provides.

According to the Internet services provided by the present invention, the user is not subordinated to the service of the website the user contacts and can freely and conveniently share information with the other users on the necessary position on the web page, get help contents to use the website on the necessary position on the web page, demand or suggest the improvement on the necessary position on the web page (the manager of the website can directly get what should be improved), place the advertisement on the necessary position on the web page to maximize the effect of the advertisement, enjoy the Internet service connected with other user such as game and chatting and enjoy the Internet service which the contacted website does not inherently provide.

Especially, the Internet service progresses on the necessary position on the web page and the user can directly recognize what the service is by the relevancy of the contents on the position and the efficiency of the service is largely increased.

Further, the user can monitor or control the hardware appliance provided in the user computer according to the website the user contacts.

Furthermore, the user can control the user computer to adjust the hardware appliances provided therein at the remote location according to the URL the user contacts.

Especially, the contact to the URL at a remote location operates the hardware appliances provided in the user computer so that the remote control or the home automation is very easily and conveniently realized.

Further, the remote control or the home automation is based on the necessary position on the web page and the user can directly recognize from the position what the hardware appliances are.

Furthermore, this remote control or home automation does not demand the user computer to be a web server. Just communication terminal equipment which can communicate with the Internet service server is sufficient as the user computer.

### BRIEF EXPLANATION OF DRAWINGS

FIG. 1 is a view showing an overall configuration of an Internet service system in connection with a contacted website according to the embodiment of the present invention;

FIGS. 2A and 2B are views showing database tables according to the embodiment of the present invention;

FIG. 3 is a view showing process of the Internet service in connection with a contacted website according to the embodiment of the present invention;

FIG. 4 is a view showing bulletin board service provided by the Internet service server in connection with a website which a user computer contacts according to the embodiment of the present invention;

FIG. 5 is a view showing help contents service and demand service provided by the Internet service server to the user computer in connection with a website which the user computer contacts according to the embodiment of the present invention;

FIG. 6 is a view showing an advertisement service in connection with a website which a user computer contacts according to the embodiment of the present invention;

FIG. 7 is a view showing an electronic commerce service in connection with a website which a user computer contacts according to the embodiment of the present invention;

FIG. 8 is a view in which the service server managed by the Internet service server in connection with a contacted website is the website which the user computer contacts;

FIG. 9 is a view showing process related to the Internet service in connection with the position on the web page of the website which the user computer contacts;

FIGS. 10 to 12 show a display on the user computer according to the Internet service in connection with the website which the user computer contacts.

FIG. 13 shows process of Internet service between the user computers in connection with the website which the user computers contact according to the embodiment of the present invention;

FIG. 14 shows a display on the user computer to which the Internet service between the user computers is provided in connection with the website which the user computers ‘contact;

FIG. 15 shows a display on the user computer to which Internet service which a website does not provide is provided in connection with the website the user computer contacts according to the embodiment of the present invention;

FIG. 16 shows a display on the user computer on which the Internet service apparatus is installed in which search and advertisement is made according to the embodiment of the present invention;

FIG. 17 shows a display on the user computer to which the electronic commerce service is provided in connection with the website the user computer contacts according to the embodiment of the present invention;

FIG. 18 shows a display when a page is moved to the linked web page and the mark is made on the particular position on the linked web page;

FIG. 19 shows a display on the user computer when the Internet service is provided on the corresponding position of the linked web page according to the embodiment of the present invention;

FIG. 20 shows a display on the user computer when the Internet service to move the web page to the linked web page and marking or providing Internet service on the particular position on the moved web page is performed in connection with the Internet service provided by the server 100 on the web page of the website displayed on the user computer;

FIG. 21 is a view showing process when the hardware on the user computer is controlled according to the website which the user computer visits according to the embodiment of the present invention;

FIG. 22 shows overall configuration when an Internet service apparatus on a user computer provides Internet service in connection with a contacted website without involvement of the Internet service server;

FIG. 23 shows a flow chart showing the operation of the Internet service apparatus according to the embodiment of the present invention.

FIG. 24 shows database table when a remote control or home automation is performed in connection with the website which the user computer contacts;

FIGS. 25 and 26 show process of the remote control or home automation to the user computer according to the present invention;

FIG. 27 shows a display on the user computer to set-up a control method in a remote control;

FIG. 28 shows, a display when the remote control is performed according to the embodiment of the present invention;

FIG. 29 shows that the hardware control method is set up in connection with the position in the remote control or home automation; and

FIG. 30 shows a display when the remote control is performed in connection with the position.

### MODE FOR INVENTION

Now, preferred embodiments of the present invention will be explained with reference to the accompanying drawings.

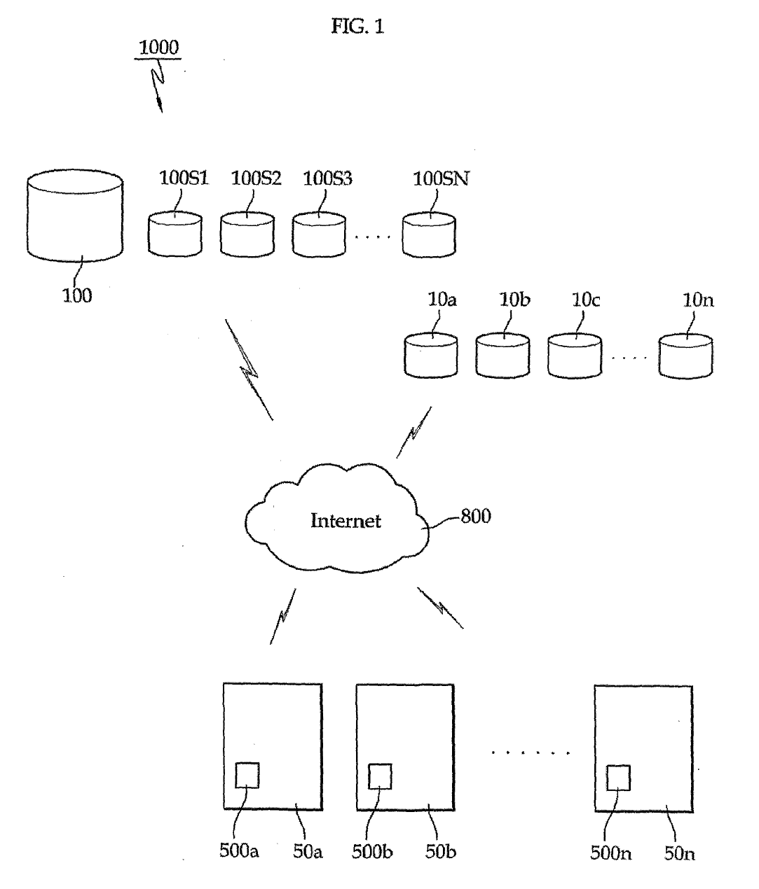

FIG. 1 is a view showing an overall configuration of an Internet service system 1000 in connection with a contacted website according to the embodiment of the present invention.

The Internet service system 1000 in connection with a contacted website according to the embodiment of the present invention includes an internet service server 100 in connection with a contacted website and user computers 50a, 50b, 50n are connected with the server 100 via Internet 800 by client-server relation.

According to the embodiment, each of the user computers 50a, 50b, . . . 50n has a web browser (not shown) and, also, has an Internet service apparatus in connection with a contacted website 500a, 500b, . . . , 500n.

The Internet service apparatus in connection with a contacted website 500a, 500b, . . . , 500n may be downloaded from the server 100 and installed on the user computer 50a, 50b, . . . 50n and, in other case, it may be stored on a storing device such as CD or USB memory device and installed on the user computer 50a, 50b, . . . ,50n.

According to the present invention, websites 10a, 10b, 10c, . . . , 10n are provided, which the user computer 50a, 50b, . . . , 50n contacts via Internet 800.

According to the embodiment, when the user computer 50a, 50b, . . . ,50n contacts the specific website 10a, 10b, 10c, . . . ,10n, the Internet service apparatus 500a, 500b, . . . , 500n transfers the URL of the contacted website to the server 100. The server 100 provides Internet service in connection with the transferred URL from the user computer 50a, 50b, . . . , 50n.

At this time, the internet service server 100 in connection with a contacted website may have a service server 100S1, 100S2, 100S3, . . . , 100SN managed by the internet service server 100 in connection with a contacted website and can provide the Internet service in connection with the URL of the website which the user computer contacts to the user computer 50a, 50b, . . . , 50n through the service server 100S1, 100S2, 100S3, . . . , 100SN.

Over all this specification, the user computer 50a, 50b, . . . , 50n is not limited to a personal computer and includes all communication device such as a PDA, a mobile phone and IPTV (Internet Protocol Television) which can connect with the servers 100 and 100S1, 100S2, . . . , 100SN through Internet 800 and sends and receives data to and from the servers 100 and 100S1, 100S2, . . . , 100SN.

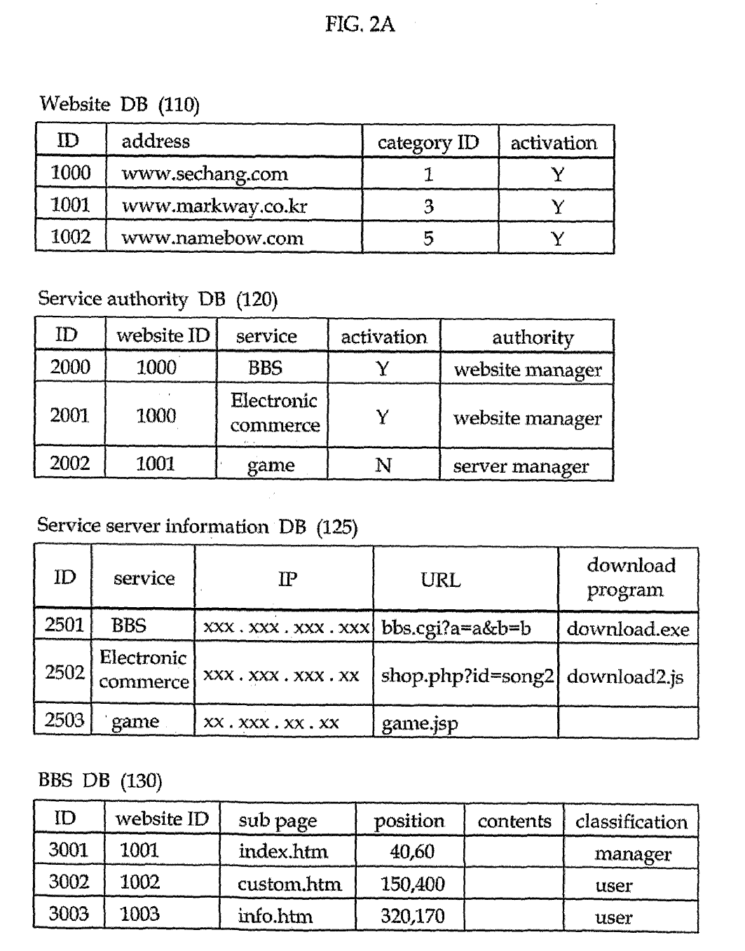

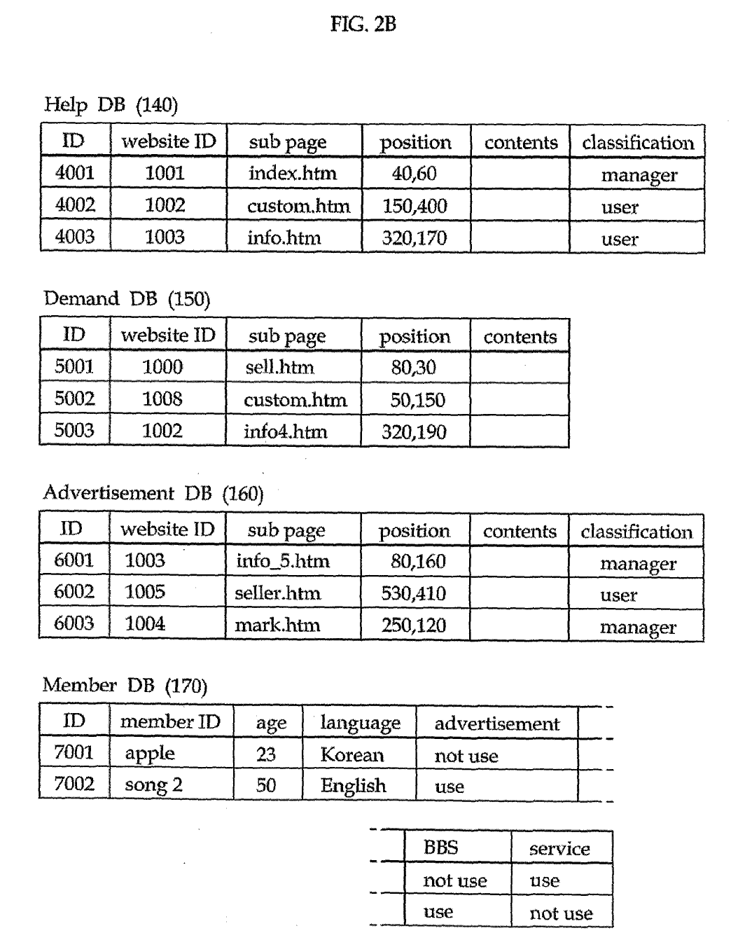

FIGS. 2A and 2B are views showing database tables according to the embodiment of the present invention.

According to the embodiment, the server 100 has a website address database 110. The website address database 110 records the domain address of the website 10a, 10b, 10c, . . . , 10n and may record whether the website address is activated.

The record whether the website address is activated is to indicate whether to provide the Internet service in connection with the corresponding domain address of the website. If it is recorded as inactivated, although the corresponding website address is recorded, the Internet service is not provided in connection with the website.

The server 100 has a service authority database 120 which records who has a management authority in connection with the Internet service provided for the user computer 50a, 50b, . . . , 50n contacting the website. In this case, the activation and the management authority may be separated in the same website domain address according to the services.

Also, the server 100 may have a service server information database 125 which records the information of the service server. The service server information database 125 records actual connection address such as IP address of the service server 100S1, 100S2, . . . , 100SN, URL for service provision and program for the service. The URL may record variables which deliver information from the Internet service apparatus 500a, 500b, . . . , 500n to the server 100 or to the service server 100S1, 100S2, . . . , 100SN.

Further, the Internet service apparatus 500a, 500b, . . . , 500n may be connected with the service server 100S1, 100S2, . . . , 100SN in real time via socket communication and, in this case, the service server information database 125 may record information related to the socket communication and additional information for security.

According to the embodiment, the server 100 may have a bulletin board database 130 and it records bulletin contents according to the domain address of the website and its sub page which the user computer contacts.

According to the present invention, when the user computer 50a, 50b, . . . ,50n contacts the specific website, the Internet service apparatus on the user computer 500a, 500b, . . . , 500n transfers the URL of the contacted website to the server 100 and the server 100 outputs the bulletin contents according to the transferred URL to the user computer 50a, 50b, . . . ,50n contacting the URL. Especially, the bulletin contents may be stored in connection with position coordinate according to the domain address and the sub page of the website. Accordingly, the server 100 may output the bulletin contents to the user computer on the position coordinate on the web page of the website displayed on the user computer. According to the embodiment, the server 100 may have a help database 140 which records help contents for using the website according to the URL of the website.

The help contents maybe classified by writer such as user or manager of the website. The help contents may be stored in connection with position coordinate according to the domain address and the sub page of the website. Accordingly, the server 100 may output the help contents to the user computer on the position coordinate on the web page of the website displayed on the user computer.

According to the embodiment, the server 100 may have a demand database 150 which records demand for improvement from the users. The users may demand or suggest the improvement in connection with the website they contact. From the demand or the suggestion, the manager of the website can know what the users want.

The demand contents may be stored in connection with position coordinate according to the domain address and the sub page of the website. Accordingly, the server 100 may output the demand contents to the user computer on the position coordinate on the web page of the website displayed on the user computer.

According to the embodiment, the server 100 may have an advertisement database 160 which stores advertisement contents according to the domain address of the website and its sub page which the user computer contacts. Accordingly, the advertisement is performed on the user computer contacting the website from the server 100.

The advertisement contents may be stored in connection with position coordinate according to the domain address and the sub page. Accordingly, the server 100 may output the advertisement contents to the user computer on the position coordinate on the web page of the website displayed on the user computer. According to the embodiment, the contents on the databases 130, 140, 150 and 160 may be various forms such as voice, moving picture, 3D and PDF file. Accordingly, the output form of the contents in the user computer 50a, 50b, . . . , 50n is also various such as voice, moving picture, 3D and PDF file.

Furthermore, the server 100 according to the embodiment may have a member database 170. The member database 170 may be filled in when users write member information such as ID and password and join as the member in getting download of the Internet service apparatus 500a, 500b, . . . , 500n from the server 100.

In other case, the server 100 may assign install ID when downloading the Internet service apparatus 500a, 500b, . . . , 500n to the user computer 50a, 50b, . . . , 50n and identify and manage the member by the install ID.

The member database 170 may record whether to use a specific service according to the member's taste and information showing features of each member such as age, language, hobby, personality, occupation, income and nationality. Accordingly, the Internet service may be provided according to the members sharing the features.

According to the embodiment, the server 100 may have the databases and, in other case, the service server 100S1, 100S2, . . . , 100SN managed by the server 100 may have the aforementioned databases. The service server information database 125 is prepared for this case.

For example, in connection with the bulletin board database 130, a bulletin board service server managed by the server 100 is provided and the bulletin board service server has the bulletin board database 130.

The server 100 or the service server 100S1, 100S2, . . . , 100SN may have various service databases according to the Internet services they provide. For example, they provide electronic commerce, chatting, message transmission and game services and have the necessary databases. The message transmission includes transmission of SMS, E-mail, voice, picture, moving picture and document file over all this specification.

The databases record the contents in connection with position coordinate according to the domain address and the sub page of the website as shown in FIGS. 2A and 2B.

Accordingly, the contents are outputted on the corresponding position coordinate of the web page according to the corresponding service.

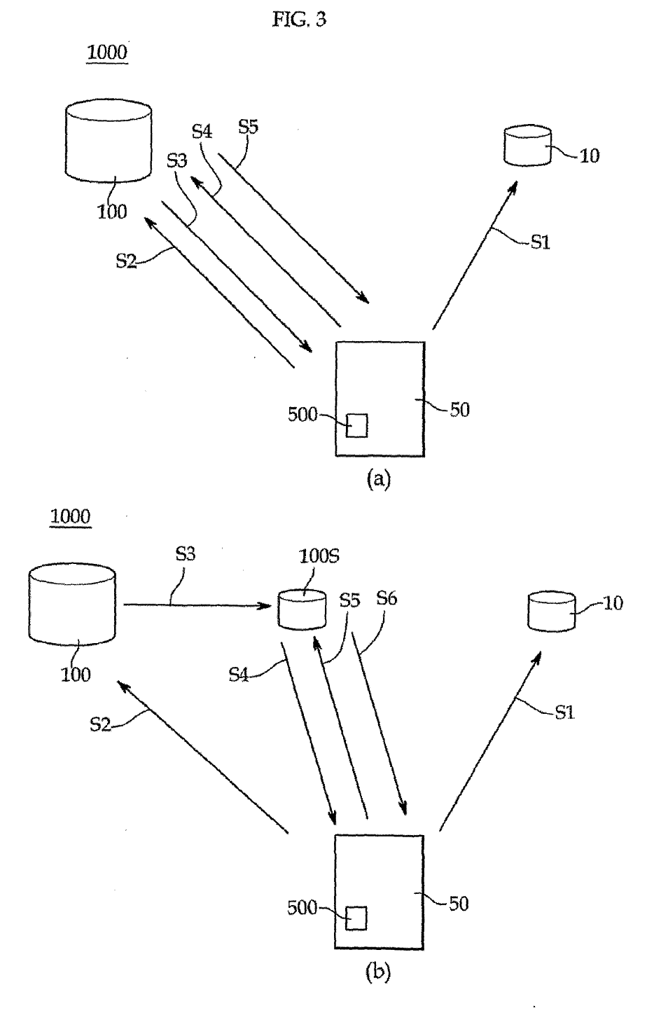

FIG. 3 is a view showing process of the Internet service in connection with a contacted website according to the embodiment of the present invention

With reference to FIG. 3(a), it is shown that the server 100 provides the Internet service to the user computer 50 which accesses the website 10 in connection with the accessed website.

Firstly, the user computer 50 accesses the website 10. (Step S1) Then, the Internet service apparatus 500 reads the accessed URL of the website 10 and transfers the URL to the server 100. (Step S2)

The server 100 reads the transferred URL and outputs service interface according to the Internet service which the server 100 provides on the web page of the website 10 displayed on the user computer 50. (Step S3)

The service interface according to the present invention means User Interface outputted to the user computer 50a, 50b, . . . , 50n which requests or guides input or action of the user and guides the user to make an output according to the service which the server 100 or the service server 100S1, 100S2, 100S3 . . . 100SN provides. The service interface includes forms such as input form or output form, button, dialog box, bulletin board and toolbar and all other things sequentially outputted subordinate to those things in order to communicate with the user. The example of the service interface will be shown in the following specific service according to the embodiment of the present invention.

The output of the service interface on the user computer 50 from the server 100 may be accomplished by various ways. For example, the service interface is realized by means of Java script, VB script or Java applet and executed and displayed on the user computer 50. In other case, the service interface is realized by means of ASP, JSP or PHP and executed on the server 100 and displayed on the user computer 50. Further, it may be displayed using the Window component through Active X.

For example, the Internet service apparatus 500a, 500b, . . . , 500n includes applet realizing the service interface and it is called and realizes the service interface according to the html codes from the server 100 and the service interface is displayed on the user computer 50a, 50b, . . . , 50n. If the applet is not included in the Internet service apparatus 500a, 500b, . . . , 500n, it will be installed thereon.

If the transferred URL is not found on the website address database 110 on the server 100, the server 100 may record the URL on the website address database 110.

At this time, the user computer 50 may transfer service data for the service inputted by the user with the position coordinate of the corresponding web page to the server 100. For example, when the user points a specific position on the web page by means of a pointing device, an input form is outputted and the user inputs the data to the input form. The user computer reads the position coordinate pointed by the point device and transfers along with the data inputted to the input form to the server 100. The form of the data includes text, voice, picture, moving picture and all other things. Also, accordingly, the forms of the data outputted from the server 100 include text, voice, picture, moving picture and all other things. In this case, for example, if the voice data is inputted and outputted, a microphone phone or speaker is equipped on the user computer. For other data forms, suitable interface device is equipped.

The pointing device includes a mouse and other things such as track ball, touch pad, light pen and tablet, as an example.

Then, the server 100 stores the transferred data on the database in connection with the URL of the corresponding website and the position coordinate of the corresponding web page as shown in FIGS. 2A and 2B. (Step S4)

Then, the server 100 outputs the service data on the position coordinate on the web page of the website displayed on the user computer according to the service interface. (Step S5) The data may be outputted in various forms such as text, voice and moving picture.

As described, the server 100 reads the URL of the website which the user computer accesses and outputs the service data stored on the service database in connection with the URL of the website and the position coordinate of the web page to the corresponding position on the corresponding web page of the website displayed on the user computer 50a, 50b, . . . 50n which contacts the URL. At this time, the server 100 stores data from the user computer on the database.

With reference to FIG. 3(b), it is shown that the service server 100S managed by the server 100 provides the Internet service to the user computer 50 which accesses the website 10 in connection with the accessed website.

Firstly, the user computer contacts the website 10. (Step S1) The Internet service apparatus 500 installed on the user computer 50 reads the accessed URL of the website 10 and transfers to the server 100. (Step S2)

The server 100 refers to the service server information database 125 for the service requested from the Internet service apparatus 500 on the user computer 50 and transfers the information including communication connection information with the user computer and condition of the member DB to the service server 100s. (Step S3) Then, the service server 100s outputs service interface according to the Internet service which the service server 100S provides on the web page of the website 10 displayed on the user computer 50. (Step S4)

At this time, the user computer 50 may transfer service data for the service inputted by the user with the position coordinate of the corresponding web page to the service server 100S.

Then, the service server 100S stores the transferred data on the database in connection with the URL of the corresponding website and the position coordinate of the corresponding web page. (Step S5)

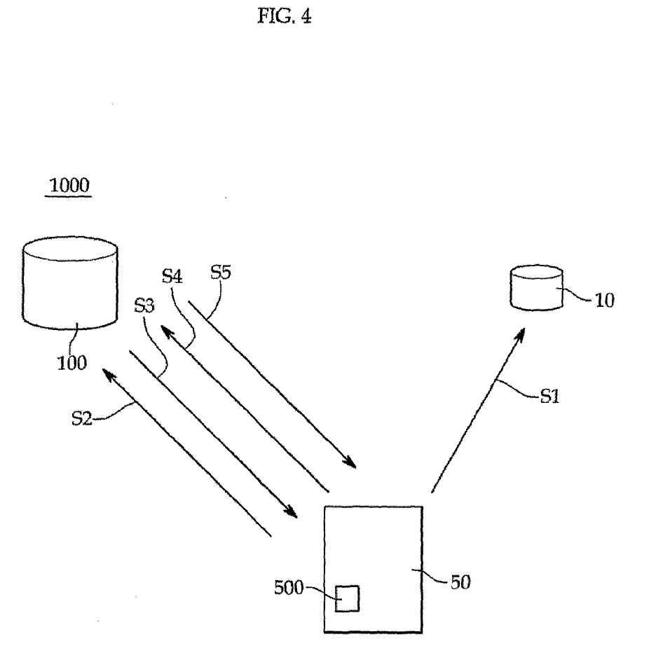

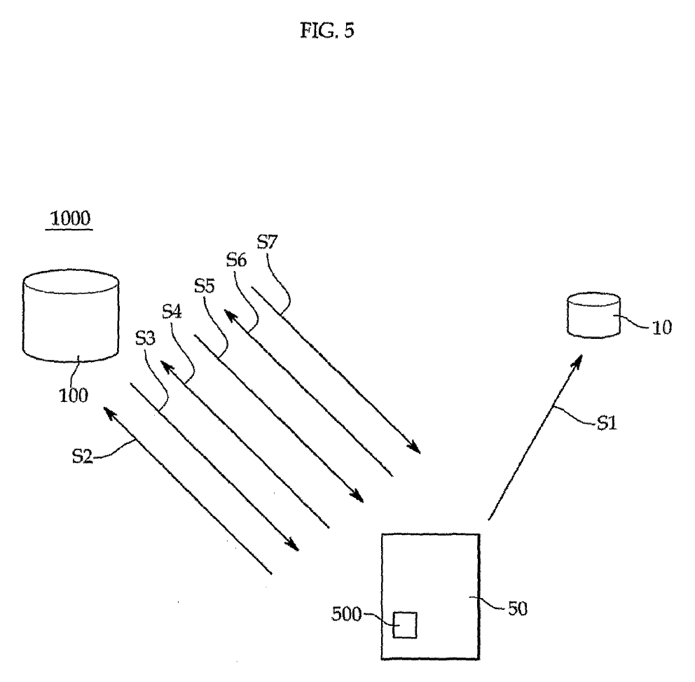

Then, the service server 100S outputs the service data on the position coordinate on the web page of the website displayed on the user computer according to the service interface. (Step S6) FIG. 4 is a view showing bulletin board service provided by the internet service server 100 in connection with a contacted website. Firstly, the user computer 50 contacts the website 10. (Step S1) Then, the Internet service apparatus 500 on the user computer 500 reads the URL of the website 10 and transfers to the server 100. (Step S2)

The server 100 reads the transferred URL of the website and outputs the service interface according to the bulletin service. (Step S3)

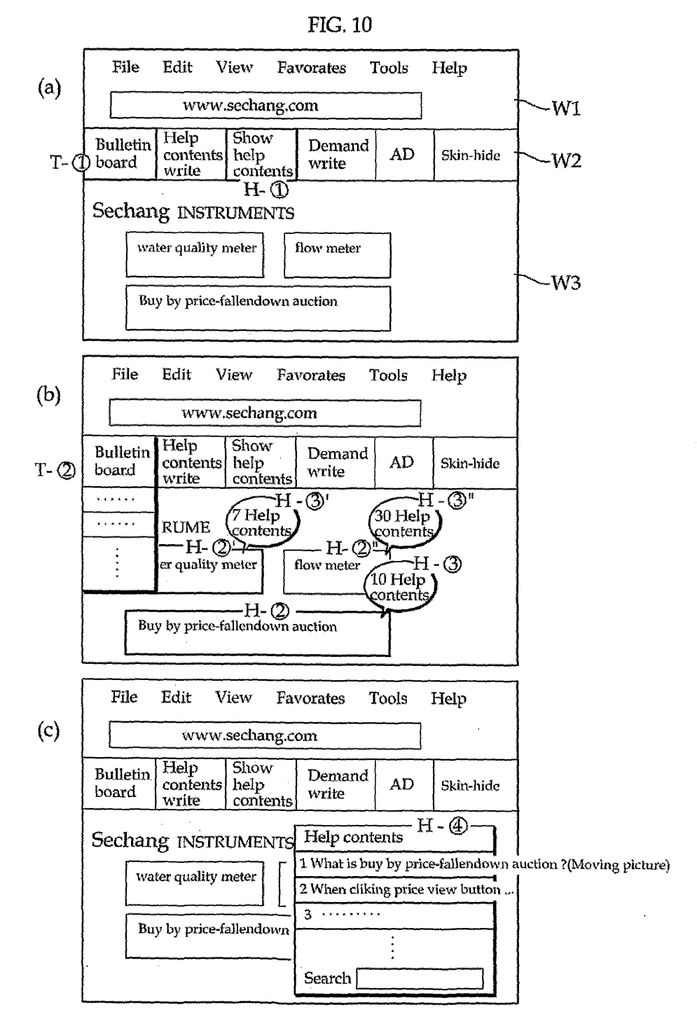

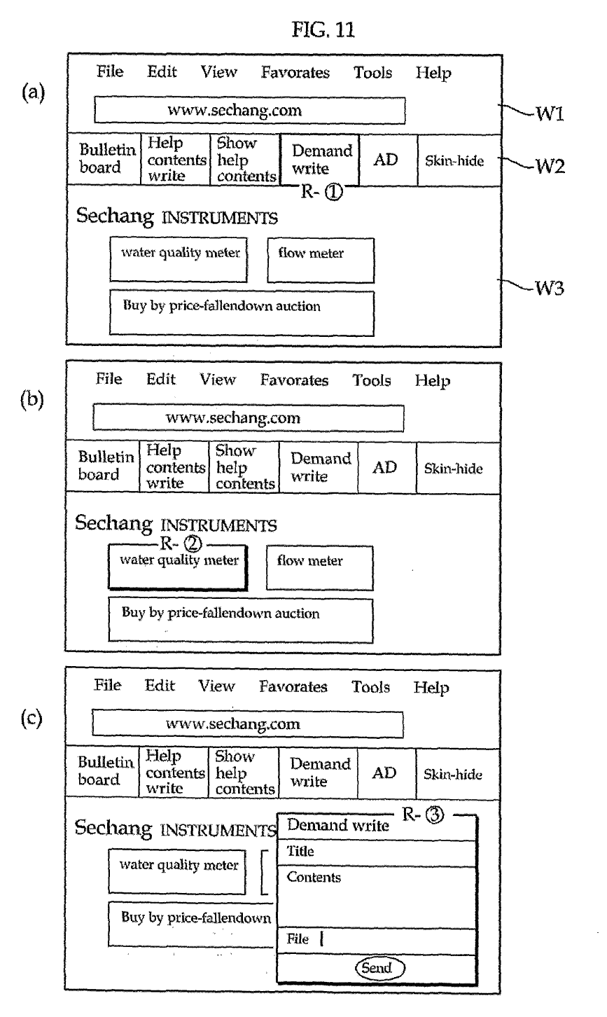

The bulletin service interface may be, for example, toolbar displayed on the web page of the website displayed on the user computer 50 (refer to W2 in FIGS. 10 and 11) and the bulletin board form appeared when the ‘bulletin board’ item is selected among the menu of the toolbar.

At this time, the user computer 50 may transfer the bulletin board contents data inputted by the user to the server 100. Then the server 100 stores the transferred bulletin board contents data on the bulletin board database 130 in connection with the URL of the website. (Step S4)

After that, the server 100 outputs the bulletin board contents data stored on the bulletin board database 130 in connection with the URL of the website to the user computer accessing the URL of the website. (Step S5)

In this case, the output of the bulletin board form may be made on the specific position on the specific web page of the website 10 and the input and output of the service data is made on the specific position on the specific web page of the website 10. The bulletin board service can be provided by the service server 1005 managed by the server 100 in connection with the URL of the website 10 which the user computer 50a, 50b, . . . , 50n contacts. The process in this case corresponds to that described with reference to FIG. 3(b).

The following other Internet service shows that the server 100 provides the Internet service, however, the service server 1005 also provides the Internet service and the process corresponds to that described with reference to FIG. 3(b).

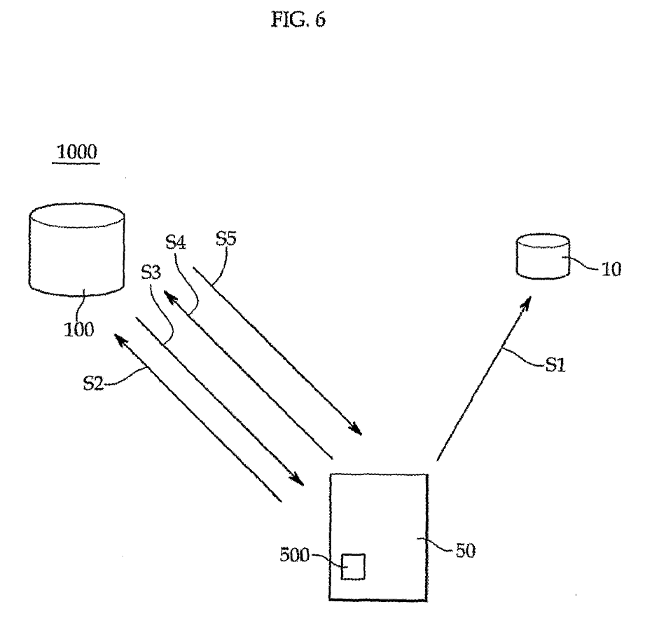

FIG. 5 is a view showing help contents service and demand service provided by the internet service server 100 to the user computer 50 in connection with the website 10 which the user computer contacts.

At this time, the help contents service is to provide help contents to the user for using the website and the demand service is to enable the user to demand or suggest improvement for inconveniences which the user feels.

Firstly, the user computer 50 accesses the specific website 10. (Step S1)

Then the Internet service apparatus 500 on the user computer 50 reads the URL of the contacted website and transfers to the server 100. (Step S2)

The server 100 reads the transferred URL of the website and outputs the service interface according to the help contents service or the demand service on the web page of the website 10 displayed on the user computer 50. (Step S3)

The help contents service interface or demand service interface may be, for example, toolbar displayed on the web page of the website displayed on the user computer 50 (refer to W2 in FIGS. 10 and 11) and the help contents service form or demand service form appeared when the ‘help’ or ‘demand’ item is selected among the menu of the toolbar.

At this time, the user computer 50 may request a help-input to the server 100 in connection with a specific position of the corresponding web page. The help-input request is to let the server 100 know that the help contents will be inputted.

If the demand service is provided, a demand-input request is made to the server 100 in connection with a specific position of the corresponding web page. The demand-input request is to let the server 100 know that the demand contents will be inputted. (Step S4)

The help-input request or the demand-input request is made by, for example, clicking ‘help contents write’ or ‘demand contents write’ item among the menu of the toolbar shown in the web page displayed on the user computer and, then, pointing the position on the displayed web page by the pointing device. (Refer to R-\textcircled{1} and R-\textcircled{2} in FIG. 11)

Then, the server 100 outputs input means on which the help contents or the demand contents will be written to the user computer on the web page. (Step S5) (Refer to R-\textcircled{3} in FIG. 11)

The input means may be input form and appear as a separate window. (Refer to FIG. 11)

The user computer 50 transfers the data inputted to the input means to the server 100 and the server 100 stores the help contents data on the help database 140 in connection with the URL of the website and the position coordinate of the corresponding web page. In connection with the demand contents data, the user computer 50 transfers the demand contents data inputted to the input means to the server 100 and the server 100 stores the demand contents data on the demand database 150 in connection with the URL of the website and the position coordinate of the corresponding web page. (Step S6)

Then, the server 100 outputs the help contents data or the demand contents data on the help database 140 or the demand database 150 on the position coordinate on the corresponding web page displayed on the user computer. (Step S7) In this case, the output may be made when the user computer designates the position of the web page and requests the output.

At this time, especially, it is desirable if the output of the demand contents data is made to a manager's computer of the website 10 which the user computer 50 contacts or to a manager's computer of the server 100. In other case, it is desirable if the server 100 provides a manager's page to which the managers can access. Accordingly, the managers get the demands and reflect them to improve, for example, the website 10.

FIG. 6 is a view showing an advertisement service in connection with a website which a user computer contacts.

Firstly, the user computer 50 contacts the website 10. (Step S1) Then, the Internet service apparatus on the user computer 500 reads the URL of the website and transfers the URL to the server 100. (Step S2)

The server 100 reads the transferred URL of the website and outputs the advertisement service interface according to the advertisement service. (Step S3)

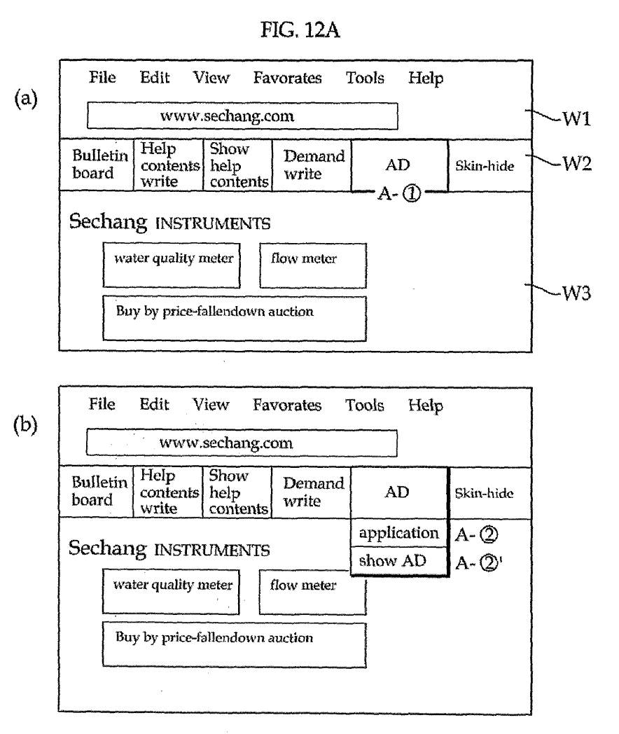

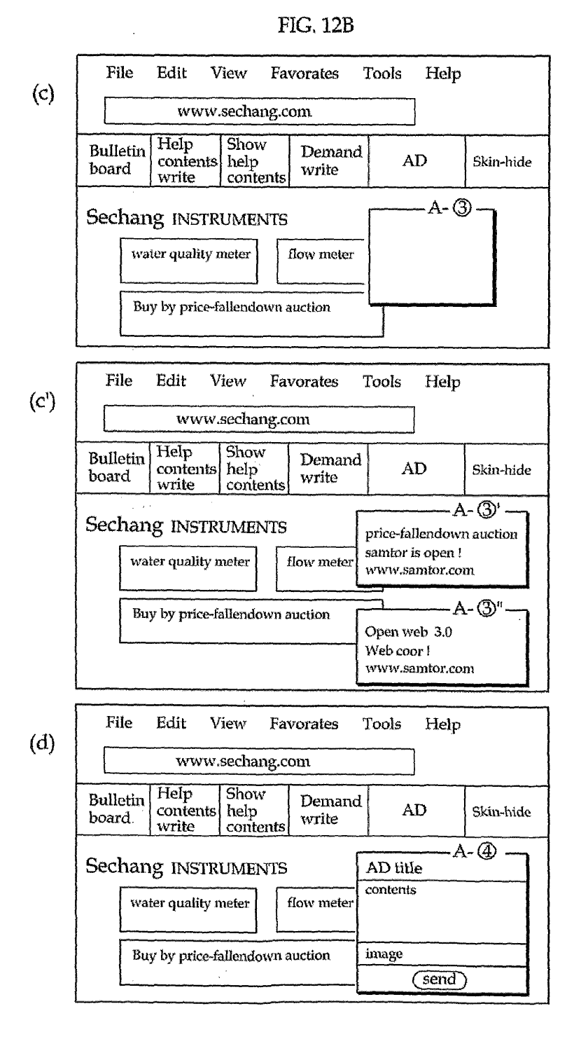

The advertisement service interface may be, for example, toolbar displayed on the web page of the website displayed on the user computer 50 (refer to W2 in FIGS. 12A and 12B) and ‘AD application’ and ‘Show AD’ appeared as the submenu when the ‘AD’ (advertisement) item is selected among the menu of the toolbar.

At this time, the user computer 50 may transfer advertisement data inputted by an advertiser to the server 100 in connection with a specific position of the corresponding web page of the website. (Refer to A-\textcircled{1} to A-\textcircled{4} in FIGS. 12A and 12B)

In this case, as described later, the advertiser may establish an advertisement area (Refer to A-\textcircled{3} in FIGS. 12A and 12B). The user computer 50 reads position coordinate which can define the advertisement area and transfers the position data to the server 100. For example, if the advertisement area is a square, the user computer 50 reads the four corner coordinate and transfers.

Then, the server 100 stores the transferred advertisement data on the advertisement database 160 in connection with the URL of the website and the position coordinate of the corresponding web page. (Step S4) At this time, the server 100 may get payment in connection with the advertisement.

Then, the server 100 outputs the advertisement contents data stored on the advertisement database 160 to the user computer 50 on the position of the corresponding web page of the website 10 displayed on the user computer 50 which contacts the website 10. (Step S5)

In this case, the output is made when the user computer request it. (Refer to A-\textcircled{2}′, A-\textcircled{3}′ and A-\textcircled{3}″ in FIGS. 12A and 12B) In this case, the advertisement is shown to only ones who record to show the advertisement in the member database 170.

Especially, according to the present invention, the output of the advertisement is made in all the web pages the URL of which includes the domain address of the website.

For example, if the website which the user computer contacts is www.sechang.com, although it is possible to output the respective advertisement in the respective sub pages, the same advertisement is outputted in the domain address www.sechang.com and its all sub directory pages such as http://www.sechang.com/shop in connection with the corresponding position.

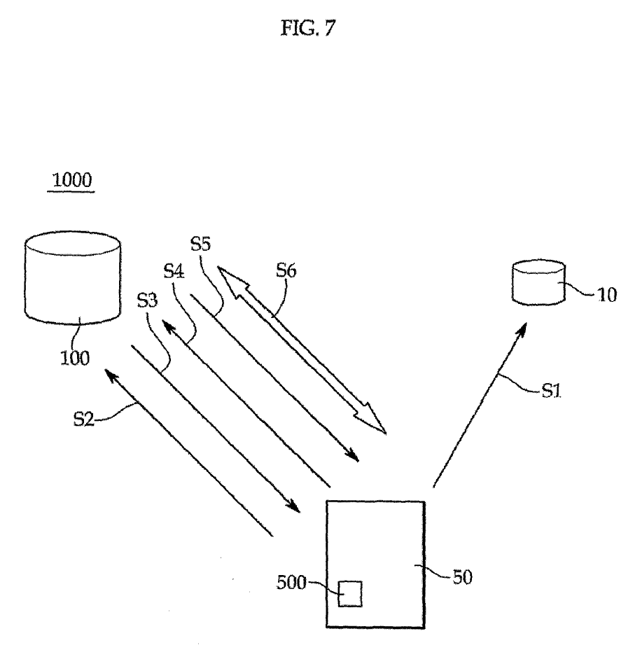

FIG. 7 is a view showing an electronic commerce service in connection with a website which a user computer contacts according to the embodiment of the present invention.

Firstly, the user computer 50 contacts the website 10. (Step S1) Then, the Internet service apparatus 500 reads the URL of the website and transfers the URL to the server 100. (Step S2)

The server 100 reads the transferred URL of the website 10 and outputs electronic commerce interface according to the electronic commerce service on the web page of the website 100 displayed on the user computer 50. (Step S3)

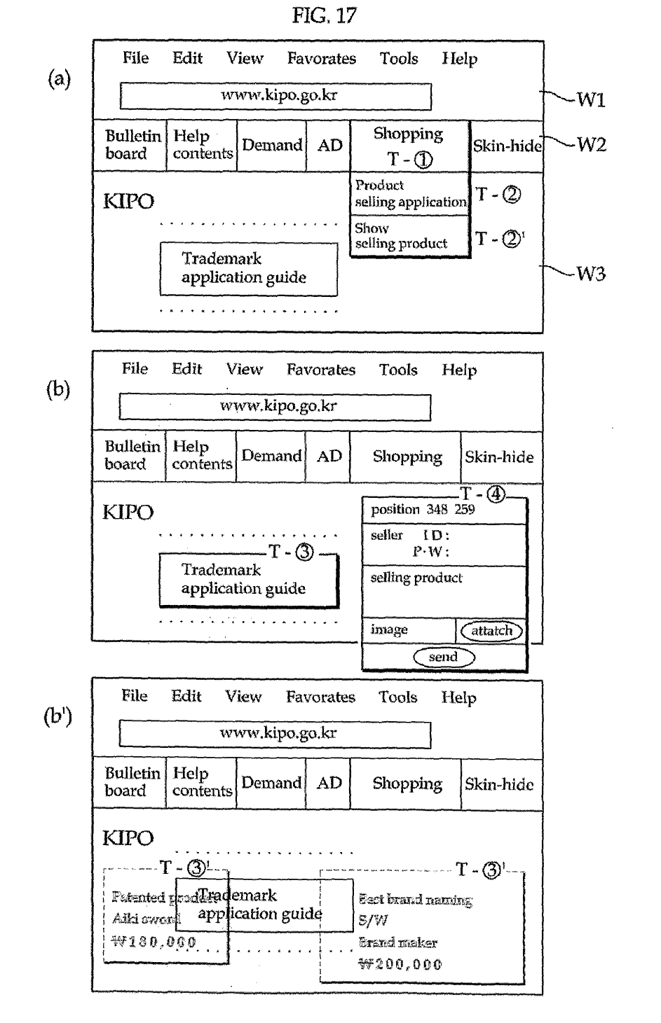

The electronic commerce interface may be, for example, toolbar displayed on the web page of the website displayed on the user computer 50 (refer to W2 in FIG. 17) and ‘Product selling application’ and ‘Show selling product’ appeared as the submenu when the ‘shopping’ item is selected among the menu of the toolbar. This electronic commerce includes, for example, shopping mall and auction.

At this time, the user computer 50 may transfer selling product data inputted by a seller to the server 100 along with the position coordinate on which the product would be exhibited on the web page of the website 10 displayed on the user computer 50.

For example, the user may designate the position for the exhibition by pointing the position on the web page displayed on the user computer by the pointing device and the user computer reads the position coordinate and transfers it with the inputted selling product data to the server 100. (Refer to T-\textcircled{1} to T-\textcircled{4} in FIG. 17)

Then, the server 100 stores the transferred selling product data on the electronic commerce database (not shown) in connection with the URL of the website and the position coordinate of the corresponding web page. (Step S4) At this time, the server 100 may get payment in connection with the selling.

Then, the server 100 outputs the selling product data to the user computer 50a, 50b, . . . , 50n which contacts the URL of the website 10 on the position coordinate of the corresponding web page of the website 10 displayed on the user computer 50a, 50b, . . . , 50n. (Refer to T-\textcircled{1} to T-\textcircled{3}′ in FIG. 17)

After that, the buyer computer 50 processes the buying process with the server 100. (Step S6)

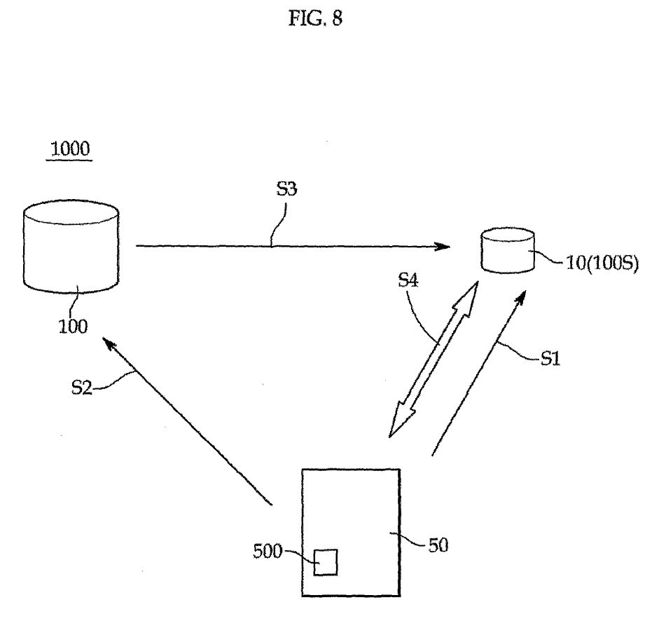

FIG. 8 is a view in which the service server 1005 managed by the server 100 is the website 10 which the user computer contacts. Firstly, the user computer 50 contacts the website 10. (Step S1)

Then, the Internet service apparatus 500 on the user computer 50 reads the accessed URL of the website 10 and transfers the URL to the server 100. (Step S2)

The server 100 refers to the service server information database 125 for the service requested from the Internet service apparatus on the user computer 50 and transfers the information including communication connection information with the user computer to the website 10 which functions as the service server 100S. (Step S3)

Then, the website 10 of the service server 100S provides the Internet service such as the bulletin board, help, demand, advertisement and electronic commerce services to the user computer 50 which contacts the website 10. (Step S4)

As described above, the present invention provides the Internet service to the user computer in connection with the URL of the website which the user computer contacts on the position of the web page of the website displayed on the user computer. For example, with respect to a menu on particular position of the web page of the website, the help and the demand services are provided in connection with the menu. In other case, if the website 10 is the shopping mall, the bulletin board service or the help contents service is provided with respect to the position on which the selling product is displayed. In other case, in a web page about electrical appliance (For example, a blog for the electrical appliance), the advertisement service or the electronic commerce service is provided with respect to the position on which the electrical appliance is displayed or worded. In other case, in a web page about news articles, with respect to the position on which particular words are stated, the relevant advertisement service or the relevant electronic commerce service is provided. For example, if ‘implant’ words are stated in the news article web page, the advertisement or electronic commerce services for a dentist or implant goods is provided with respect to the implant words position.

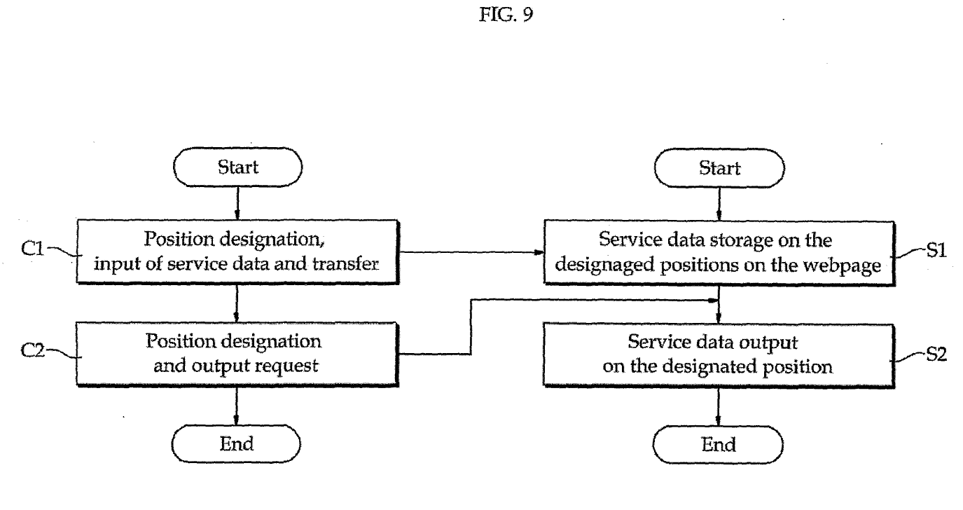

FIG. 9 is a view showing process related to the Internet service in connection with the position on the web page of the website which the user computer contacts.

Firstly, the user computer 50a, 50b, . . . , 50n contacts the website 10 and the web page of the website 10 is displayed on the user computer 50a, 50b, . . . ,50n.

The Internet service apparatus 500a, 500b, . . . , 500n on the user computer 50a, 50b, . . . , 50n reads the URL of the website 10 transfers to the server 100. Accordingly, the user computer can communicate with the server 100 and receive data from the server 100.

At this state, the user designates the position on the web page displayed on the user computers 50a, 50b, . . . , 50n and inputs the service data in connection with the position.

Then, the user computers 50a, 50b, . . . , 50n transfers the service data with the position of the web page to the server 100. (Step C1)

For example, the user designates the particular position on the web page by the pointing device. For example, the user places a mouse cursor on the position and clicks to designate the position. In this case, the Internet service apparatus 500a, 500b, . . . , 500n reads the coordinate of the position and transfers the coordinate with the inputted data to the server 100.

For example, the server 100 may accept as service data input request if the position is designated on the web page of the website displayed on the user computer and output the service data input form. Then the user inputs the service data to the service data input form and the Internet service apparatus 500a, 500b, . . . , 500n transfers the position coordinate of the web page and the inputted data to the server 100.

Then the server 100 stores the service data and the position coordinate of the web page on the service database in connection with the URL of the website. (Step S1)

If the user designates particular position on the web page of the website displayed on the user computer 50a, 50b, . . . , 50n and requests output (Step C2), the server 100 outputs the service data stored in connection with the position and the URL of the website to the user computer 50a, 50b, . . . , 50n on the corresponding position. (Step S2)

The steps C1 and S1 may not be always necessary. That is, the server 100 readily stores the service data according to the URL of the website and the position of the web page and outputs them on the corresponding position of the web page. Further, the server 100 may output without the step C2.

When the server 100 outputs the service data on the position of the web page of the website displayed on the user computer 50a, 50b, . . . , 50n, the server 100 may previously show presence of the service data on the corresponding position of the web page of the website 10 displayed on the user computer.

That is, according to the position coordinate of the web page and the corresponding service data stored on the server 100, the server 100 displays the presence of the service data on the position on which the service data is present on the web page of the website displayed on the user computer. In this case, it is preferable if the number of the service data is shown.

The display of the presence of the service data may be shown by a figure. For example, word balloon, circle or star figure may be shown.

For example, in FIG. 10(b), on the respective position H-\textcircled{2}, H-\textcircled{2}′ and H-\textcircled{2}″ on which water quality meter, flowmeter and buy by price-fallen down auction are shown, respectively, in the web page of www.sechnag.com which the user computer contacts, the word balloons are displayed indicating that the number of the help contents is 7, 30, and 10 on the respective position. (Refer to H-\textcircled{3}, H-\textcircled{3}′ and H-\textcircled{3}″)

If there is the request from the user computer in connection with the positions H-\textcircled{2}, H-\textcircled{2}′ and H-\textcircled{2}″, the service data stored on the positions are outputted. (Refer to H-\textcircled{4} in FIG. 10(c))

According to the present invention, the position coordinate on the web page of the website displayed on the user computer can be obtained by compensating an absolute coordinate from the screen with scrolled value along up and down or left and right.

In other case, the position coordinate may be calculated with reference to a particular object such as particular text or mark in html code in the web page of the website displayed on the user computer. In this case, when the server 100 outputs the service data on the web page displayed on the user computer, the position is determined with reference to the object.

Also, according to the embodiment of the present invention, the server 100 receives resolution data of the user computer from the

Internet service apparatus 500 thereof and if the resolution of the user computer is different from the reference resolution, it converts or makes the Internet service apparatus 500 convert the position coordinate according to the ratio between the reference resolution and the resolution of the user computer.

FIGS. 10 and 11 show a display on the user computer according to the Internet service in connection with the website which the user computer contacts.

Firstly, FIG. 10(a) shows the initial display on the user computer 50a, 50b, . . . , 50n.

As shown, toolbar W1 according to the web browser is displayed on the upper portion and toolbar W2 is displayed as the service interface according to the present invention below the toolbar W1. Below the toolbar W2, web page W3 of the website is displayed. In this case, the website which the user computer contacts is www.sechnag.com as shown in the address in the toolbar W1 and the toolbar W2 is displayed on the user computer from the server 100. The toolbar W2 shows ‘bulletin board’, ‘help contents write’, ‘show help contents’, ‘demand write’, ‘AD’ (advertisement) and ‘skin-hide’ as the service which the server 100 provides in cooperation with the Internet service apparatus 500.

In this case, the skin is an indication to show the presence of the service data on the positions on which the service data are present and the skin-hide is an indication to hide the skin so that the skin showing the presence of the service data is hided and not shown when it is clicked.

For example, when the bulletin board is clicked as indicated by T-\textcircled{1} in FIG. 10(a), the bulletin board is extended as indicated by T-\textcircled{2} in FIG. 10(b) and the bulletin board contents in connection with www.sechang.com are appeared.

When the ‘show help contents’ is clicked as indicated by H-\textcircled{1} in FIG. 10(a), the number of the help contents are shown by words balloon figures as indicated by H-\textcircled{3}, H-\textcircled{3}′ and H-\textcircled{3}″ in connection with the positions as indicated by H-\textcircled{2}, H-\textcircled{2}′ and H-\textcircled{2}″ where the help contents are stored.

At this state, when the number of the help contents in H-\textcircled{3} is clicked, the help contents is outputted as indicated by H-\textcircled{4} in FIG. 10(c). In this case, the help contents are outputted as the bulletin board form.

In other case, as shown in FIG. 11, when the user clicks the demand write on the toolbar W2 (R-\textcircled{1} in FIG. 11(a)) and clicks the position on which the water quality meter is displayed (R-\textcircled{2} in FIG. 11(b)), the input form is outputted by pop-up in connection with the position (R-\textcircled{3} in FIG. 11(c)).

Then the user inputs the demand to the input form and the inputted data and the position coordinate are transferred to the server 100 and are stored in connection with the www.sechang.com.

The services may be directly displayed without the skin (if the skin-hide is used).

Further, for example, if the cursor of the mouse is placed on a position and the right button of the mouse is clicked or the cursor is stayed for a while, menu window including service data input and service data output is pop-up. And, if the service data input is clicked, the input form is outputted and the user can input the data thereto. Then, the inputted data along with the position coordinate is transferred to the server 100 and stored on the service database in connection with the corresponding URL. If the service data output is clicked, the service data stored in connection with the position of the web page is outputted.

FIGS. 12A and 12B show a display on the user computer according to the advertisement service in connection with the website which the user computer contacts.

As shown, toolbar W1 according to the web browser is displayed on the upper portion and toolbar W2 is displayed as the service interface according to the present invention below the toolbar W1. Below the toolbar W2, web page W3 of the website is displayed. If the AD is clicked from the menu of the toolbar W2 (A-\textcircled{1} in (a) of FIG. 12A)), ‘AD application’ and ‘show AD’ are appeared as the submenu. ((b) of FIG. 12A)

The AD application is clicked to request the advertisement application. (A-\textcircled{2} in (b) of FIG. 12A)

Then, position on which the advertisement is displayed is designated. For example, the drag and drop of the mouse establishes the area on which the advertisement is displayed. In this case, the user computer reads position coordinate to define the established area. As shown, if the square is established, the user computer reads the four corner-coordinates.

Then, the server 100 outputs input interface to which the advertisement data is inputted in connection with the web page. For example, the input form is outputted as shown in A-\textcircled{4} of Fig. (d) of FIG. 12B and if the advertisement data is inputted thereto and the send button is clicked, the advertisement data is transferred to the server 100.

If the ‘show AD’ (A-\textcircled{2}′) is clicked in the submenu of the AD in (b) of FIG. 12A, the advertisements are outputted on the corresponding positions (A-\textcircled{3}′ and A-\textcircled{3}″) as shown in (c′) of FIG. 12B.

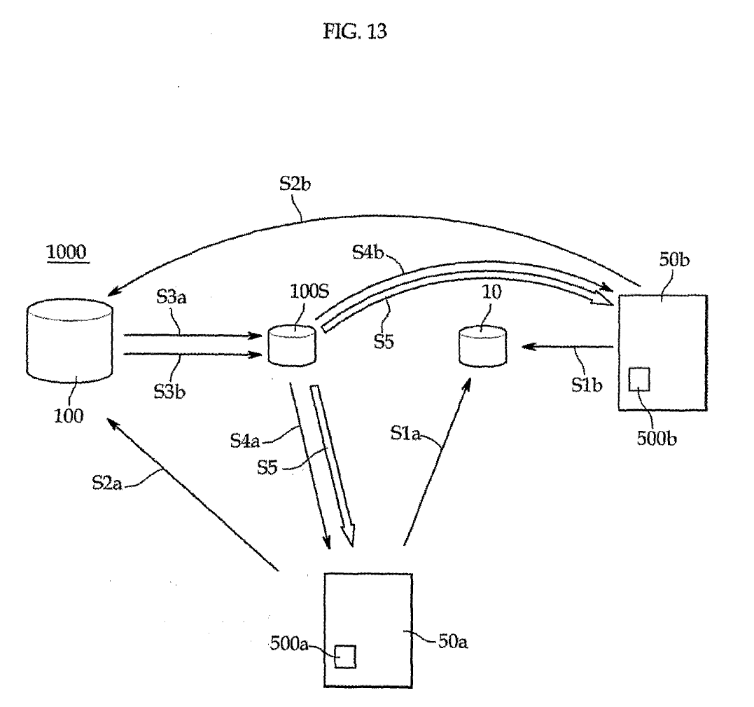

FIG. 13 shows process of Internet service between the user computers 50a and 50b in connection with the website which the user computers 50a and 50b contact.

Firstly, the user computers 50a and 50b contact the website 10. (Steps S1a and S1b)

Then, the Internet service apparatuses 500a and 500b on the user computers 50a and 50b transfer the URL of the website 10 to the server 100. (Steps S2a and S2b)

Then, the server 100 transfers the transferred URL of the website and the connection information such as socket communication information with the user computers 50a and 50b to the service server 100S managed by the server 100. (Steps S3a and S3b)

Then, the service server 100S outputs list of the user computers which contact the website 10 to the user computers. (Steps S4a and S4b)

In this case, with respect to the user computer 50a, the user computer 50b is outputted and with respect to the user computer 50b, the user computer 50a is outputted.

For this, for example, the member database 170 records connection location and connection time in real time for each of the member and it is possible to find the user computers which contact the website at present. In other case, the service server 100S records connection logs and can find the user computers which contact the website at present. In other case, it is possible to find the user computers which contact the website at present by receiving the connection information via socket communication in real time. Then, the user computers 50a and 50b select one from the outputted user computers which contact the website and the service server 100S relays the user computer and the selected user computer and provides the Internet service between them. (Step S5)

The Internet service provided between the user computers may be, for example, chatting, game, and message transmission.

Especially, in connection with SMS, when outputting the user computers which contact the website at present, the mobile phone numbers of the user computers may be outputted together and the selection of the counter user computer may include the input of the mobile phone number to the service server 100s. In this case, it is preferable if the mobile phone number of the message sender is inputted together.

At this time, the member database 170 records the mobile phone number of each member and the selection of the counter user computer accompany the input of the mobile phone numbers of the sender and the receiver.

As the same case in sending E-mail, the member database 170 records the E-mail address of each member and the selection of the counter user computer accompanies the input of the E-mail address of the sender and the receiver.

FIG. 13 shows that the service server 100S managed by the server 100 provides the Internet service between the user computers. However, the service ma be provided by the server 100 without the service server 100S.

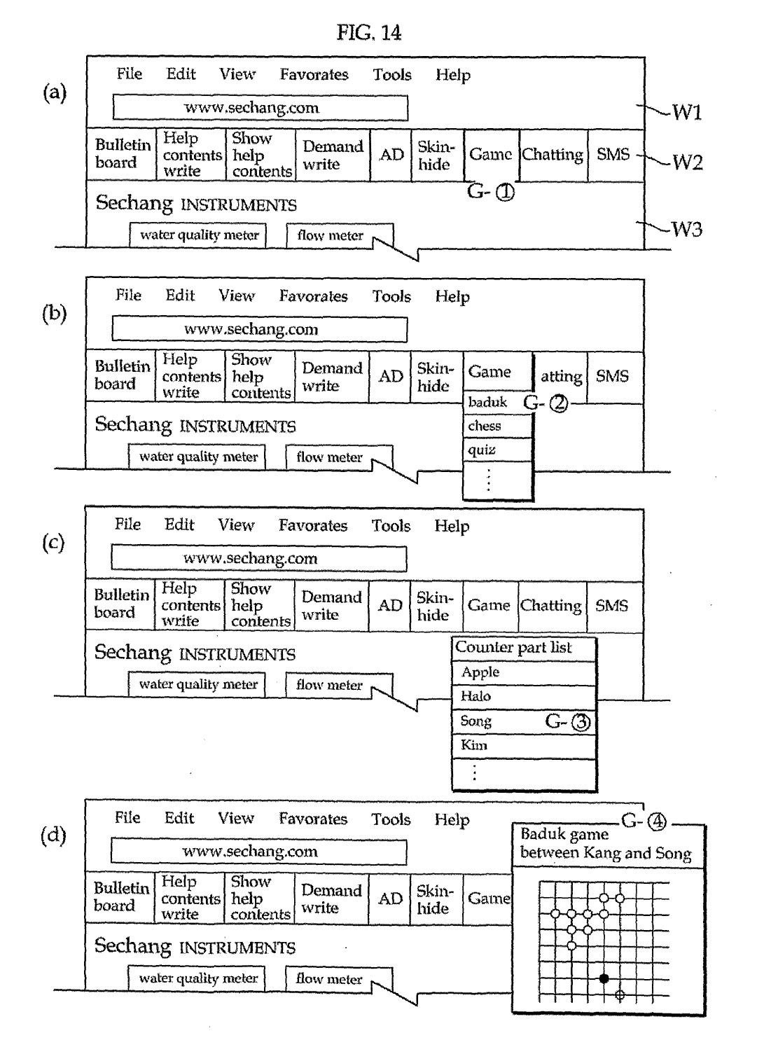

FIG. 14 shows a display on the user computer according to the Internet service between the user computers in connection with the website which the user computers contact.

Firstly, as shown, in FIG. 14(a), toolbar W1 according to the web browser is displayed on the upper portion and toolbar W2 is displayed as the service interface according to the present invention below the toolbar W1. Below the toolbar W2, web page W3 of the website www.sechang.com which the user computer accesses is displayed. In this case, when game is selected from the menu of the toolbar W2 (G-\textcircled{1} in FIG. 14(a)), the various game titles are appeared (G-\textcircled{2} in FIG. 14(b)). When the specific game is selected, the list of the user computers which contact the website www.sechang.com at present are outputted. (G-\textcircled{3} in FIG. 14(c))

One of them is selected and selected counter part permits the game, then, the game is displayed and is conducted between the user computers. (G-\textcircled{4} in FIG. 4(d))

According to the present invention, as shown in the service authority database 120, the management authority may be different according to the website which the user computer contacts or the Internet service. Further, the help contents may be classified by writer such as manager of the website and user and be outputted according to the classification.

Further, according to the present invention, the service data stored on the service databases in connection with the URL of the website may be classified by the character and stored by the classification. In this case, the service data may be outputted to the user computer according to the classification.

As described above, the present invention provides Internet service in which the Internet service apparatus 500a, 500b, . . . , 500n on the user computer 50a, 50b, . . . , 50n transfers the URL of the website 10 which the user computer contacts to the internet service server 100, then, the Internet service server 100 provides the Internet service to the user computer 50a, 50b, . . . , 50n in connection with the web page of the website 10 displayed on the user computer 50a, 50b, . . . , 50n, especially, on the position of the web page.

According to the present invention, the Internet service server 100 in connection with a contacted website can provide service which the website 10a, 10b, 10c, . . . , 10n which the user computer 50a, 50b, . . . , 50n contacts does not provide. In this case, the

Internet service server 100 in connection with a contacted website takes a role of a kind of ASP (Application Service Provider). At this time, the server 100 or the service server 100S managed by the server 100 stores position data at which the internet service is provided. For example, the service server information database 125 may store the position data.

In this case, the website 10 which the user computer 50 contacts may include call program which makes the Internet service apparatus 500 downloaded to the user computer 50 from the server 100 or the service server 100S in its web page file, especially, in connection with the position of the web page at which the Internet service is provided.

Then, the user of the user computer 50 which contacts the website 10a, 10b, 10c, . . . , 10n operates the call program on the web page and makes the Internet service apparatus 500 downloaded from the server 100 or the service server 100S to the user computer 50 and installed thereon. In other case, the Internet service apparatus 500 may be installed on the user computer 50 through a portable memory device such as USB.

Accordingly, when the user computer accesses the website, the Internet service apparatus 500 on the user computer reads the URL of the website and transfers to the server 100.

Then, the server 100 or the service server 1005 reads the transferred URL and recognizes Internet service, web page and position corresponding to the URL, accordingly, provides the Internet service on the position of the web page of the website displayed on the user computer 50.

The Internet service which the server 100 or service server 100S provides to the user computer which contacts the website 10 may be various from member management to bulletin board, game, auction, chatting and message transmission.

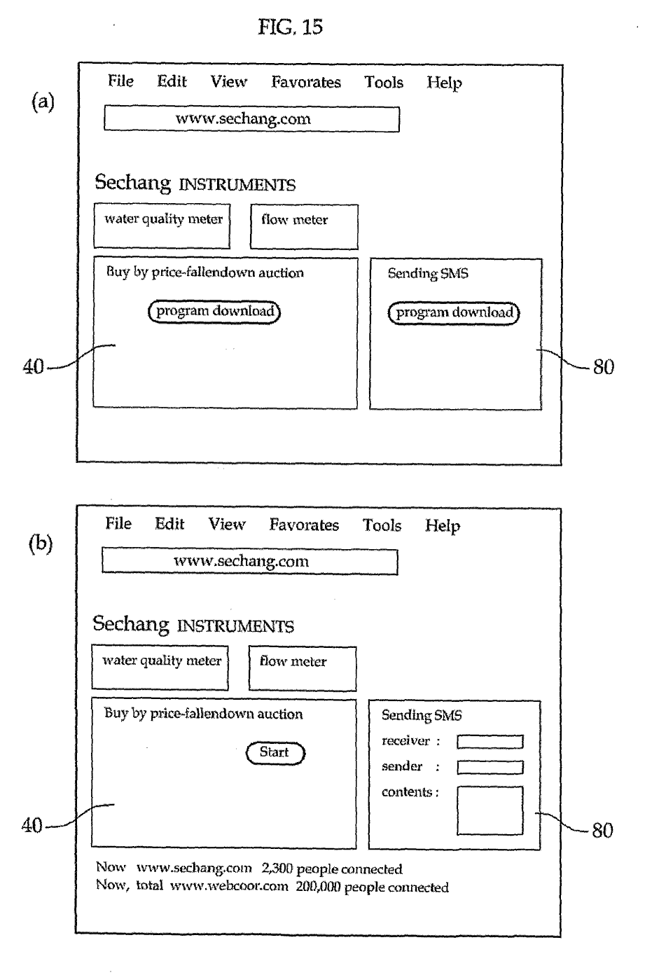

FIG. 15 shows a display on the user computer according to Internet service which a website does not provide in connection with the website the user computer contacts according to the embodiment of the present invention.

Firstly, FIG. 15(a) shows the state in which the Internet service apparatus 500 is not installed on the user computer 50. In this case, on the positions 40 and 80 at which the services are provided from the server 100 or the service server 100S, it is expressed to download the Internet service apparatus 500.

Accordingly, the user of the user computer 50 clicks the position 40 or 80 and operates the call program and gets download of the Internet service apparatus 500 from the server 100 or the service server 1005 to the user computer 50 and installs the Internet service apparatus 500 on the user computer 50.

If installed as described above, as shown in FIG. 15(b), the Internet service interface provided by the server 100 or the service server 100S is displayed on the positions 40 and 80 of the web page displayed on the user computer 50 and, then, the server 100 or the service server 1005 provides the corresponding Internet service to the user computer 50 on the corresponding position.

At this time, if the Internet service apparatus 500 is installed on the user computer 50 after its download by clicking either of the positions 40 and 80 at which the Internet service is provided, the Internet service interface provided by the server 100 or the service server 1005 is displayed on all the positions 40 and 80 as shown in FIG. 15(b)

In other case, the Internet service apparatus is different from each other according to the respective Internet service and is downloaded for each Internet service.

In this view, the server 100 or the service server 1005 provides price fallen type auction service and SMS service to the user computer 50 which contacts the website www.sechang.com at the positions on 40 and 80, respectively.

Especially, the users connected with www.sechang.com are shown in the lower portion of FIG. 15(b). It means the user computers which contact www.sechang.com and are connected with the server 100 through the Internet service apparatus 500.

Also, the user computers which contact other website than www.sechang.com and are connected with the server 100 through the Internet service apparatus 500 are shown. In this case the server 100 is www.webcoor.com.

When the user computers on which the Internet service apparatus 500 are installed contact the website 10a, 10b, . . . , 10n, the server 100 can recognize them and mediate and provide the Internet service therebetween.

For example, the server 100 identifies the user computers which contact a particular website and display the list. Then, when the user computer selects a counterpart from the list, the server can provide the Internet service therebetween. The Internet service may be chatting, game or message transmission.

According to the present invention, the server 100 may provide a search function to the user computer 50a, 50b, . . . , 50n. That is, the server 100 stores relevant key words corresponding to the URL of the website and makes the user computer connected therewith through the Internet service apparatus 500 search them.

For example, additional fields are provided in the website address database 110, the bulletin board database 130 or the advertisement database 160 in FIGS. 2A and 2B for storing the key words corresponding to the URL and the server 100 provides search form to input the key words and find the related URL to the user computer 50a, 50b, . . . , 50n on the web page of the website displayed on the user computer 50a, 50b, . . . , 50n.

Accordingly, the user inputs the key words on the user computer 50a, 50b, . . . , 50n and the server 100 outputs the corresponding URL to the user computer 50a, 50b, . . . , 50n. In this case, it is preferable if the URL outputted on the user computer 50a, 50b, . . . , 50n is linked via hyper link to contact it directly.

Further, it is desirable if the server 100 stores the advertisement data as shown in the advertisement database 160 in FIG. 120 and outputs the advertisement data on the web page of the website displayed on the user computer.

In this case, it is desirable if the advertiser pays for the advertisement and the advertisement profit is distributed between the owner of the server 100, the owner of the website and the user (advertisement viewer).

For this, a settlement database storing the payment for the advertisement and a distribution database storing the distribution between the owner of the server 100, the owner of the website and the user may be provided.

The profit distribution may be based on factors such as number of the user connected to the website and page views.

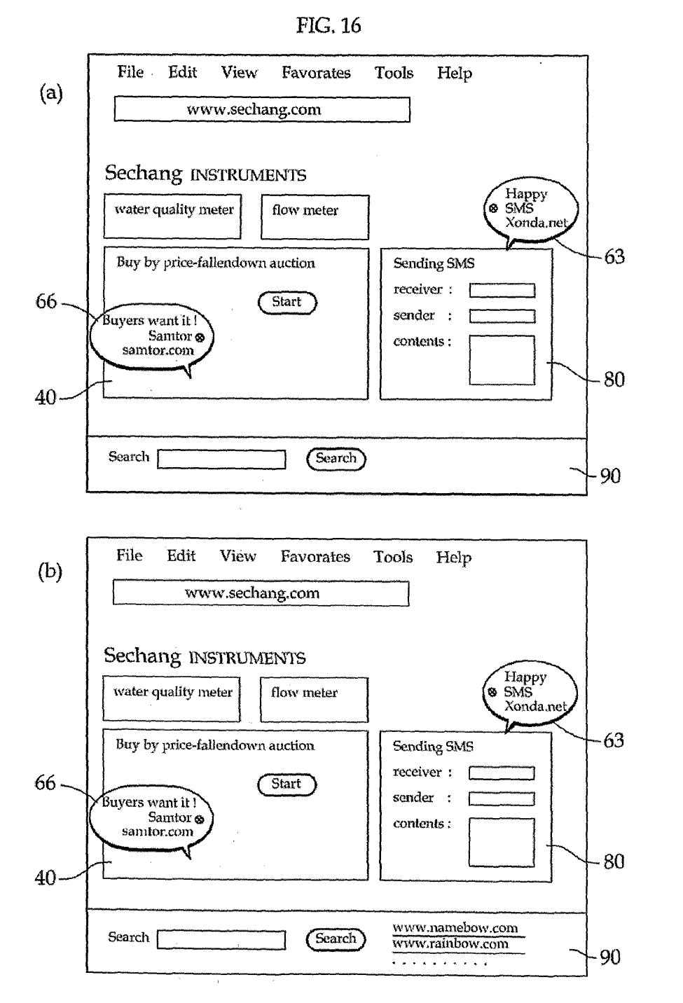

FIG. 16 shows a display on the user computer 50a, 50b, . . . ,50n on which the Internet service apparatus is installed in which the search and the advertisement is made.

Firstly, the service interface is displayed on the corresponding positions 40 and 80 on the web page of the website displayed on the user computer 50a, 50b, . . . , 50n and, in this case, the search window 90 is also displayed thereon.

Also, as indicated by numerals 63 and 66, the advertisements are displayed. In this view, the display of the advertisements is made by balloon figures including advertisement words therein. If the keyword is inputted to the search window 90, the corresponding website is shown. In this view, the key word is ‘naming’ and the corresponding websites are outputted.

FIG. 17 shows a display on the user computer to which the electronic commerce service is provided in connection with the website the user computer contacts.

As shown, the toolbar W1 according to the web browser is displayed on the upper portion and the toolbar W2 as the service interface is displayed below the toolbar W1. The web page W3 is displayed below the toolbar W3.

In this case, the user computer contacts www.kipo.go.kr as shown in toolbar W1 and the toolbar W2 is outputted to the user computer which contacts www.kipo.go.kr by the server 100.

The toolbar W2 shows various service menu including shopping. With reference to FIG. 17(a), if the shopping is clicked, ‘product selling application’ and ‘show selling product’ are appeared as the submenu.

If the ‘product selling application’ is clicked (T-\textcircled{2}) and the exhibition position is pointed (T-\textcircled{3} in FIG. 17(b)), an input form to which the selling product information is inputted is outputted in connection with the pointed position. (T-\textcircled{4} in FIG. 17(b)) Then the seller inputs the selling product information and pushes the send button. The information along with the position of the corresponding web page is transferred to the server 100 and stored. If the ‘show selling product’ is clicked (T-\textcircled{2}′ in FIG. 17(a)), the shopping products are exhibited on the corresponding positions as shown in FIG. 17(b′).

According to the present invention, it is possible to move to a particular position of a linked web page from the web page of the website which the user computer contacts. That is, it is possible to move to the linked web page plus to the particular position from the web page of the website which the user computer contacts. In this case, the link code on the web page of the website the user computer contacts includes URL of the linked web page and position coordinate on the linked web page. For example, the html codes include the link code.

Accordingly, if the link code including the URL of the linked web page and position coordinate on the linked web page is clicked on the present web page, the Internet service apparatus 500 on the user computer reads the link code and interprets it and recognizes the position coordinate. Reading the link code is possible through hooking, for example.

Then, the Internet service apparatus 500 on the user computer controls the web browser to access to the linked URL and makes a mark on the position on the linked web page.

Accordingly, the web page according to the linked URL is displayed on the user computer and mark is made on the corresponding position coordinate on the linked web page on the user computer. The mark is, for example, to place the cursor, shadow or display an arrow on the corresponding coordinate.

This service is very useful, especially for reference. That is, it is to mark the position on which the referred information is located beyond the display of the referred web page.

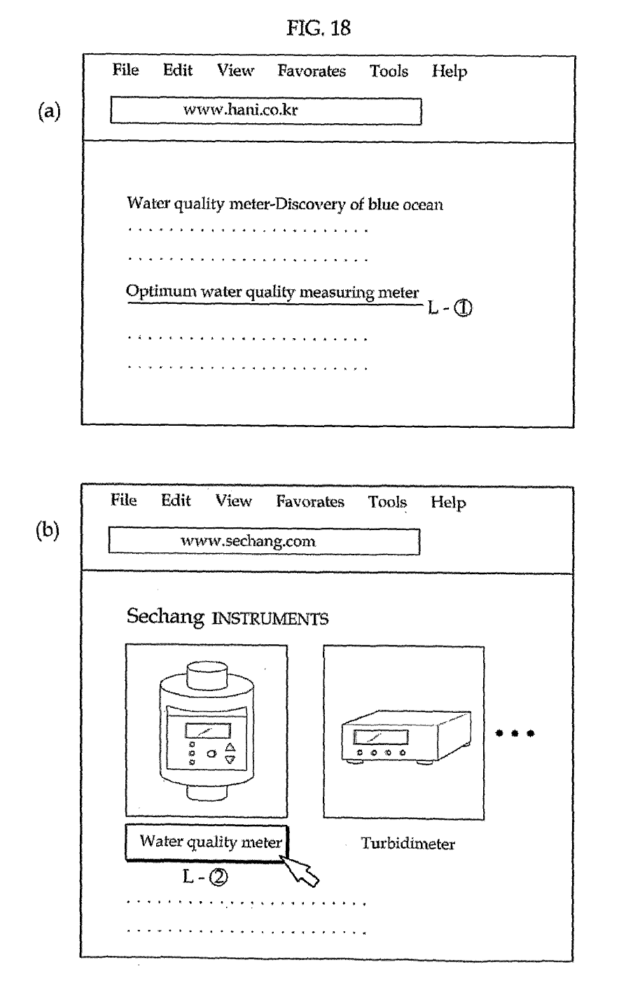

FIG. 18 shows a display when a page is moved to the linked web page and the mark is made on the particular position.

Firstly, with reference to FIG. 18(a), the user computer accesses to www.hani.co.kr and the web page of the www.hani.co.kr is displayed. The web page contains an article regarding water quality meter and the portion of ‘optimum water quality measuring meter’ (L-\textcircled{1}) includes the html codes including the link to other web page and the position coordinate.

For example, the source code of the L-\textcircled{1} portion may be “<a href=“http://www.sechang.com?pos=200_{—}400”>optimum water quality measuring meter</a>”.

If the portion is clicked, the Internet service apparatus 500 hooks the source code and interprets it and move the web page to www.sechnag.com and make a mark on the position coordinate of 200 and 400 (L-\textcircled{2}). The mark is made by the arrow on the position (L-\textcircled{2}) as shown in FIG. 18(b).

In other case, the source code of the L-\textcircled{1} portion may be “<a href=“http://webcoor.com/go.php?website=sechang.com&pos=200_{—}4 00”>optimum water quality measuring meter</a>”.

Accordingly, if the portion is clicked, the Internet service apparatus 500 hooks the source code and interprets ‘sechang.com&pos=200_{—}400’ below ? and move the web page to www.sechnag.com and make the mark on the position coordinate of 200 and 400 (L-\textcircled{2}).

In this case, if the user computer does not have the Internet service apparatus 500, the hooking is not realized and the page moves to http://webcoor.com/go.php. From the moved web page, the user computer can download the Internet service apparatus 500.

Accordingly, the user who contacts www.hani.co.kr and reads the article regarding water quality meter at first time moves to the L-\textcircled{2} portion of www.sechang.com and become intuitively recognized that the product according to the article is the product shown on the marked position of the moved web page.

According to the present invention, it is possible to provide Internet service on particular position after moving web page beyond marking on the position after moving the web page.

In this case, the html code in the web page includes the link code containing URL of other web page to be linked, position coordinate and Internet service information.

If the link code is clicked, the Internet service apparatus 500a, 500b, . . . , 500n hooks the link code and transfers the URL of other web page to be linked, position coordinate and Internet service information to server 100.

The Internet service apparatus 500a, 500b, . . . ,500n controls the web browser to access to the linked URL and the web page of the linked URL is displayed on the user computer. The server 100 provides the Internet service on the corresponding position coordinate of the web page displayed on the user computer.

The Internet service includes the bulletin board, the help contents, the demand contents, the advertisement and the electronic commerce and the process is in accordance with the described process.

Further, in other case, the html code in the web page includes URL of web page to be linked and identification information which identifies position coordinate and Internet service to be provided. At this time, the server 100 stores the position coordinate and the Internet service corresponding to the identification information.

If the link code is clicked, the Internet service apparatus 500a, 500b, . . . , 500n hooks the linked URL and the identification information and transfers them to the server 100.

The Internet service apparatus 500a, 500b, . . . , 500n controls the web browser to access to the linked URL and the server 100 recognizes the position coordinate on the linked web page and the Internet service according to the identification information.

Accordingly, the web page of the linked URL is displayed on the user computer and the server 100 provides the Internet service on the corresponding position coordinate of the web page displayed on the user computer.

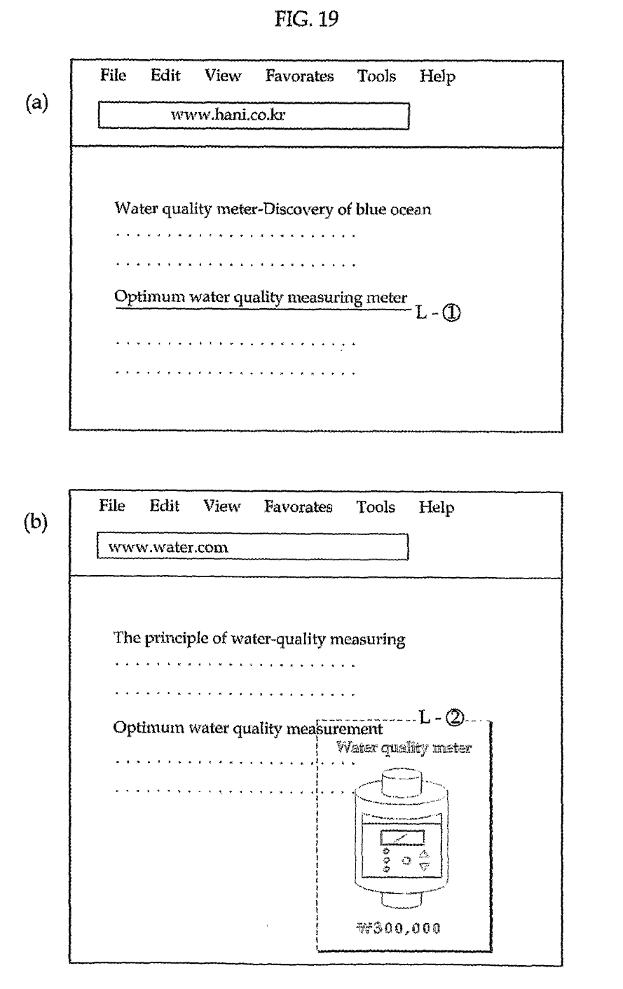

FIG. 19 shows a display on the user computer when the Internet service is provided on the corresponding position of the linked web page.

Firstly, with reference to FIG. 19(a), the user computer contacts www.hani.co.kr and the web page of the www.hani.co.kr is displayed. The web page contains an article regarding water quality meter and the portion of ‘optimum water quality measuring meter’ (L-\textcircled{1}) includes the html codes including the link to other web page, the position coordinate on the linked web pate and the Internet service information.

For example, the source code of the L-\textcircled{1} portion in FIG. 19(a) may be “<a href=“http://www.water.com?pos=200_{—}400&id=1_{—}1234”>optimum water quality measuring meter</a>”.

If the portion is clicked, the Internet service apparatus 500 hooks the source code and interprets it and move the web page to www.water.com and transfers the position coordinate 200 and 400 and id=1_{—}1234 which indicates the Internet service to the server 100.

Then, the server 100 outputs the electronic commerce service the id of which is 1 for the product the id of which is 1234 on the position of 200 and 400 on the www.water.com web page displayed on the user computer.

With reference to FIG. 19(b), the web page of www.water.com is displayed and the water quality meter the id of which is 1234 is exhibited as the selling product on the position coordinate of 200 and 400 (L-\textcircled{2})). If the portion (L-\textcircled{2})) is clicked, the electronic commerce is progressed and the water quality meter is purchased. In other case, the source code of the L-\textcircled{1} portion in FIG. 19(a) may be “<a href=“http://www.water.com?id=1_p2_{—}1234”>optimum water quality measuring meter</a>”.

If the portion is clicked, the Internet service apparatus 500 hooks the source code and interprets it and move the web page to www.water.com and transfers the linked URL www.water.com and identification information of id=1_p2_{—}1234 to the server 100. Then, the server 100 outputs the electronic commerce service corresponding to 1 in connection with the URL of www.water.com on the position of 200 and 400 corresponding to p2 for the product corresponding to id=1234 on the lined web page of www.water.com displayed on the user computer.

With reference to FIG. 19(b), the web page of www.water.com is displayed and the water quality meter the id of which is 1234 is exhibited as the selling product on the position coordinate of 200 and 400 (L-\textcircled{2}) the id of which is p2. If the portion (L-\textcircled{2}) is clicked, the electronic commerce is progressed and the water quality meter is purchased.

In this case, the linked www.water.com publishes professional articles regarding the water quality meter and at ‘optimum water quality measurement’ location in the contents, corresponding water quality meter is exhibited so that the user intuitively recognizes the product and directly purchases it.

Further, in other case, in FIG. 19(a), the source code in L-\textcircled{1} portion may be “<a href=“http://webcoor.com/go.php?website=www.water.com&pos=200_{—}400&id=1_{—}1234”>optimum water quality measuring meter</a>” or “<a href=“http://webcoor.com/go.php?website=www.water.com&id=1_p2_{—}1234”> so that the web page is moved to webcoor.com/go.php to download the Internet service apparatus 500 if the user computer does not have the Internet service apparatus 500.

According to the present invention, to move the web page to the linked web page and marking or providing Internet service on the particular position is performed in connection with the Internet service provided by the server 100 on the web page of the website displayed on the user computer.

In this case, the service data which the server 100 outputs to the user computer includes link code containing URL of the linked web page and position coordinate on the linked web page. Further, the link code further includes internet service information in connection with the URL of the linked web page. The inclusion in the link code may be identifiers corresponding to each of the information.

Accordingly, if the link code is clicked in the service data outputted to the web page of the website displayed on the user computer, the information is hooked by the Internet service apparatus 500 and the web browser on the user computer contacts the linked URL and the mark is made on the corresponding position. In other case, the Internet service apparatus 500 transfers the information to the server 100 and the server 100 recognizes the corresponding position coordinate and the Internet service in connection with the URL. Then, the server 100 provides the Internet service on the position on the linked web page displayed on the user computer.

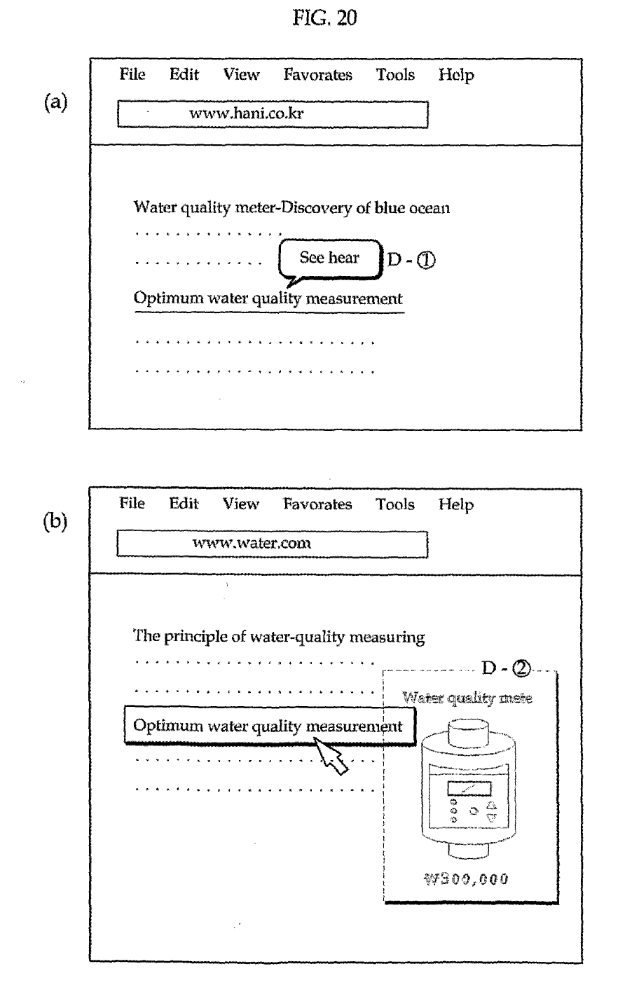

The Internet service includes the bulletin board, the help contents, the demand contents, the advertisement and the electronic commerce and the process is in accordance with the described process. FIG. 20 shows a display on the user computer when the Internet service to move the web page to the linked web page and marking or providing Internet service on the particular position on the moved web page is performed in connection with the Internet service provided by the server 100 on the web page of the website displayed on the user computer.

Firstly, as shown in FIG. 20(a), the user computer contacts www.hani.co.kr and the article for the water quality meter is displayed. Here, for the portion of ‘optimum water quality measuring meter’, the server 100 provides the help contents by the words balloon figure stating “see here” (D-\textcircled{1}). The html code in the “see here” portion (D-\textcircled{1}) includes the link to another web page and the position coordinate and the Internet service information to be provided.

For example, the source code of the “see here”” portion (D-\textcircled{1}) may be “<a href=“http://www.water.com?pos=200_{—}400&id=1_{—}1234”>‘see here’</a>” and the “see here” portion (D-\textcircled{1}) is clicked, the Internet service apparatus 500 hooks the information and transfers to the server 100 and makes the web browser contacts the www.water.com.

Then, the mark is made and the water quality meter is exhibited as the selling product on the position coordinate on the web page of the www.water.com. FIG. 20(b) shows that the mark is made and the water quality meter is exhibited as the selling product on the ‘optimum water quality measurement’ portion (D-\textcircled{2}). After that, the buying process with the server 100 may be processed by clicking the exhibited water quality meter.

In this case, as a matter of course, it is possible to just mark or exhibit the selling product on the position.

In other case, the source code of the “see here” portion (D-\textcircled{1}) may be “<a href=“http://www.water.com?id=1_p2_{—}1234”>‘see here’</a>”.

Also, the source code of the “see here” portion (D-\textcircled{1}) may be “<a href=”http://webcoor.com/go.php?website=www.water.com&id=1_p2_{—}1234”>‘see here’</a>” for moving to the http://webcoor.com/go.php from which the Internet service apparatus 500 is downloaded if the Internet service apparatus is not installed on the user computer.

Further, the source code of the “see here” portion (D-\textcircled{1}) may be “<a href=”http://webcoor.com/go.php?id=35_{—}1_p2_{—}1234”>‘see here’</a>”. In this case id 35 corresponds to www.water.com. According to the present invention, the server 100 may record logs of the user computers to move along the website 10a, 10b, . . . , 10n. These may be used for statistical material.

According to the present invention, it can be determined whether a web page is renewed in connection with a particular position of the web page of the website which the user computer contacts.

In this case, when a particular position is designated by pointing the position on the web page of the website displayed on the user computer, the Internet service apparatus 500 captures an area around the position and calculates the data size and transfers the size of the data with the position data to the server 100.

In this case, distance from the pointed position by a specific length to upper, bottom, right and left may define the area. The server 100 stores the data size in connection with the URL and the position coordinate and compares the data size in connection with the position coordinate according to the URL. If the change of the data size is detected, the server 100 determines that the web page is renewed at the position.

The server 100 may display the renewal or not according to the position on the web page displayed on the user computer. According to the present invention, it is possible to control a hardware appliance provided in the user computer in connection with the website which the user computer contacts. That is, the server 100 controls the hardware appliance provided in the user computer 50a, 50b, . . . , 50n in connection with the website 10a, 10b, . . . ,10n which the user computer contacts. In this case, the operation of the hardware appliance changes according to the website the user computer contacts.

For example, if there are websites A, B and C, the operation of the hardware appliance in the same user computer varies when the user computer visits the website A or website B or website C. Specifically, when the user computer visits the website A, a radio is turned on, when the user computer visits the website B, a lamp is tuned on and when the user computer visits the website C, an alarm is tuned on.

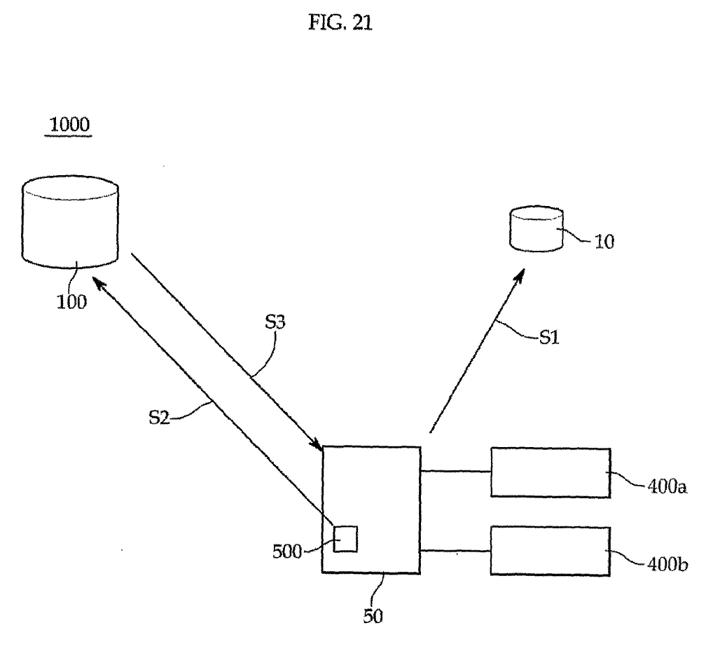

FIG. 21 is a view showing process when the hardware appliance provided in the user computer is controlled according to the website which the user computer visits.

Firstly, the server 100 stores unique value indicating the hardware provided in the user computer in connection with the URL of the website.

The unique value may be set up when the user computer accesses to the server 100 and records thereon.

For example, the unique value indicating the hardware appliance provided in the user computer is IP address, Mac address and port number connected with the hardware appliance of the user computer. Follow shows the example of the database in this case.

Hardware Information Database

| Hard- | | | | | |
|---|---|---|---|---|---|
| ware | user | user computer | port | des- | present |
| ID | computer IP | Mac address | No. | cription | state |
| 3000 | 202.131.30.83 | 00-16-EC-F7-5A-B1 | 1 | radio | operate |
| 3001 | 202.131.30.83 | 00-16-EC-F7-5A-B1 | 2 | lamp | not |
| | | | | | operate |

Hardware Control Database

| website ID | sub page | hardware ID | control method |
|---|---|---|---|
| 2001 | bbs.html | 3000 | . . . |
| 2002 | info,html | 3001 | . . . |

The hardware information database records that radio and lamp are mounted on the user computer the IP address and Mac address of which are 202.131.30.83 and 00-16-EC-F7-5A-B1 through the port number 1 and 2, respectively. Also, the hardware control database records the hardware ID in connection with the URL of the website which the user computer contacts. The hardware control database can record the control method. The control method includes ON/OFF control and other various control method such as proportional control.

At this state, the user computer 50 contacts the website 10 through the Internet 800. (Step S1)

Then, the Internet service apparatus 500 on the user computer 50 reads the URL of the website and transfers the URL to the server 100 and requests control command controlling the operation of the hardware appliance to the sever 100 (Step S2)

Then, the server 100 identifies the hardware appliance according to the transferred URL and transmits control code defining the operation of the hardware appliance according to the URL to the Internet service apparatus 500 on the user computer 50. (Step S3) Accordingly, the user computer 50 can control the hardware appliance in connection with the URL according to the control code received and the hardware appliance operates.

In this case, the unique value indicating the hardware provided in the user computer in connection with the URL of the website is recorded in connection with the each of the member and the hardware appliance is controlled according to the member in connection with the URL. In this case, all the services such as the bulletin board service, the help contents service, the demand service, the advertisement service and the game service according to the present invention are integrated to be used. For example, the hardware information database may record the member ID corresponding to the respective hardware ID.

According to the present invention, an Internet service apparatus 5000 which provides Internet service in connection with a contacted website is provided and, in this case, the Internet service in connection with the contacted website is possible without involvement of the Internet service server 100.

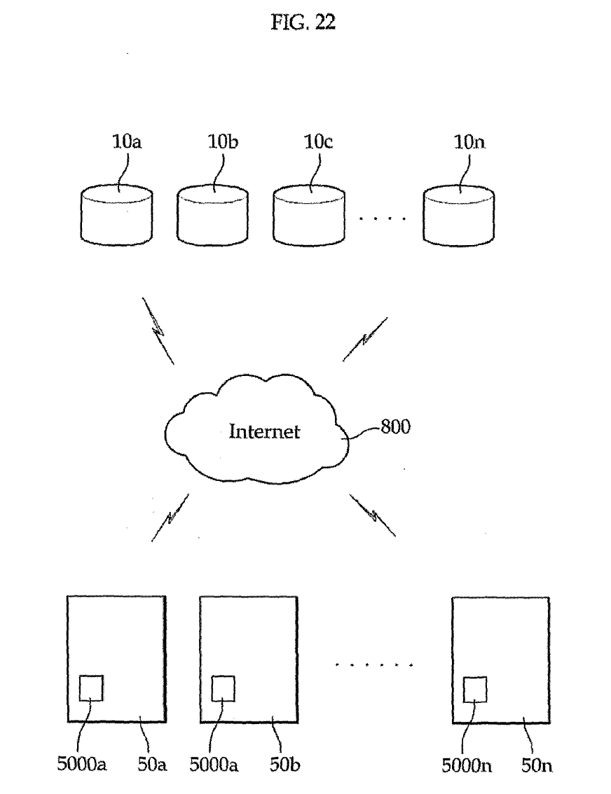

FIG. 22 shows overall configuration in this case.

Firstly, the user computer 50a, 50b, . . . , 50n has the web browser and connects to the website 10a, 10b, 10c, . . . 10n through the Internet 800. The user computer 50a, 50b, . . . , 50n has the Internet service apparatus 5000a, 5000b, . . . ,5000n which provides the Internet service in connection with a contacted website.

The Internet service apparatus 5000a, 5000b, . . . , 5000n includes a service data storage means which stores service data in connection with the URL of the website which the user computer contacts and positions on the web page of the website displayed on the user computer.

The Internet service apparatus 5000a, 5000b, . . . , 5000n may be downloaded from a website and installed on the user computer 50a, 50b, . . . , 50n and, in other case, it may be stored on a storing device such as CD or USB memory and installed on the user computer 50a, 50b, . . . ,50n.

Further, the Internet service apparatus may be installed on a portable memory device such as USE and be executed by, for example, auto run, when the portable memory device is connected to the user computer.

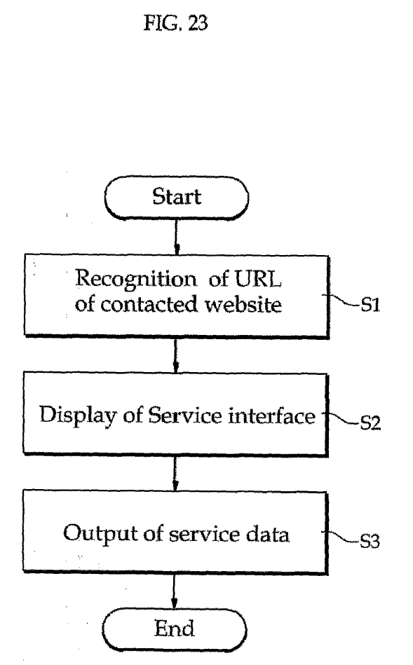

FIG. 23 shows a flow chart showing the operation of the Internet service apparatus 5000.

Firstly, the user computer 50a, 50b, . . . , 50n contacts the website 10. Then, the Internet service apparatus 5000a, 5000b, . . . , 5000n recognizes the URL of the website. (Step S1)

The user computer contacts the website and the web page of the website is displayed on the user computer. At this state, the Internet service apparatus 5000a, 5000b, . . . , 5000n displays the service interface according to the service on the web page of the website displayed on the user computer. (Step S2)

Then, the Internet service apparatus 5000a, 5000b, . . . , 5000n outputs the service data in connection with the URL of the website on the corresponding position on the web page of the website displayed on the user computer. (Step S3)

For example, the service provided by the Internet service apparatus 5000a, 5000b, . . . , 5000n is the help contents service which provides the help contents to the user for using the website.

That is, when the user computer on which the Internet service apparatus 5000a, 500b, . . . , 500n is installed contacts the website, the Internet service apparatus 5000a, 500b, . . . , 500n outputs the help contents on the corresponding position on the web page of the website displayed on the user computer. The help contents service interface in this case corresponds to that provided by the Internet service server 100 as described above.

In other case, the service provided by the Internet service apparatus 5000a, 5000b, . . . , 5000n is the advertisement service on the web page of the website displayed on the user computer. That is, when the user computer on which the Internet service apparatus 5000a, 500b, . . . , 500n is installed contacts the website, the Internet service apparatus 5000a, 500b, . . . , 500n outputs the advertisement on the corresponding position on the web page of the website displayed on the user computer. The advertisement service interface in this case corresponds to that provided by the Internet service server 100 as described above.

According to the present invention, remote control or home automation in connection with a website the user computer contacts is possible.

In this case, the Internet service server 100 stores unique value indicating hardware appliance provided in the user computer in connection with URL of the website. Further, the control method may be stored therewith.

The unique value and the control method may be set up when the user computer accesses to the server 100 and records thereon.

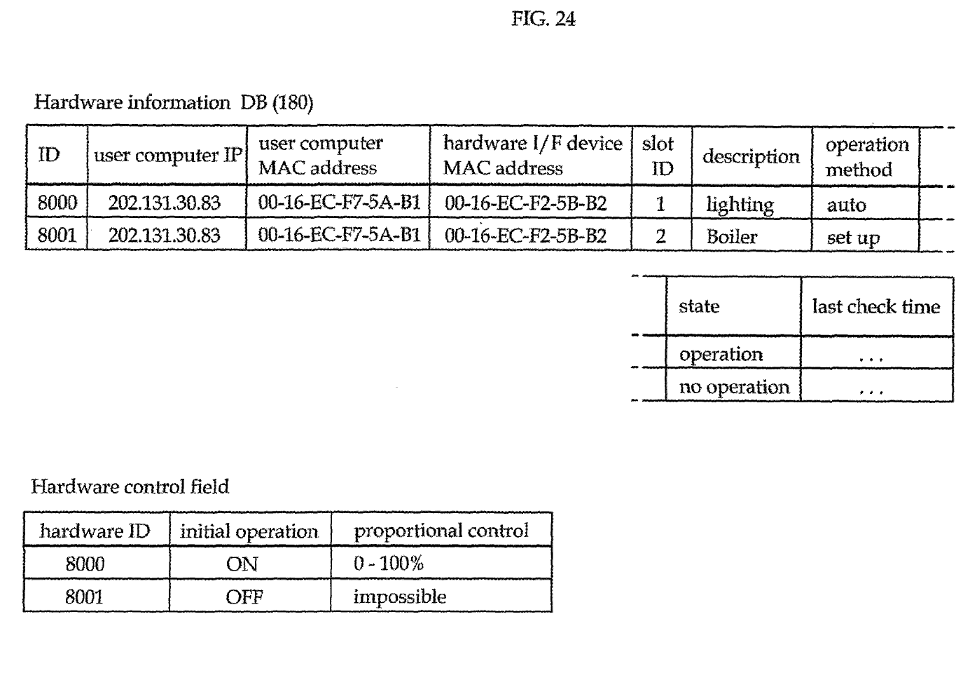

FIG. 24 shows database tables in this case.

Firstly, hardware information database 180 is shown, which stores hardware appliance information provided in the user computer.

The hardware information database records that lighting and boiler are connected with the user computer the IP address and Mac address of which are 202.131.30.83 and 00-16-EC-F7-5A-B1 through hardware interface device the Mac address of which is 00-16-EC-F2-5B-B2 on its slot IDs 1 and 2, respectively.

In this case, the hardware interface device 480 is a kind of hub to connect a variety of hardware appliances with the user computer. Also, the hardware control field is shown which records the hardware appliance and the control method in connection with the URL of the website. The hardware control field may be incorporated into the bulletin board database 130, the help contents database 140, the demand database 150 or the advertisement database 160. In other case, an independent database is provided and the hardware control field is recorded corresponding to the URL of the website thereon. In this case, as for the light and the boiler provided in the user computer the IP address and Mac address of which are 202.131.30.83 and 00-16-EC-F7-5A-B1 (the hardware IDs 8000 and 8001), it is recorded that the initial operation are ON and OFF, respectively and that the proportional control is possible for the lighting and impossible for the boiler.

The control method includes ON/OFF control, proportional control and other various method.

If the hardware database field is incorporated into the bulletin board database 130, the help contents database 140, the demand database 150 or the advertisement database 160, as described later, the remote control or the home automation is possible in connection with the position of the service data in the databases and, if necessary, in connection with the service data as well.

Especially, although not shown, each of the unique value indicating the hardware appliance provided in the user computer and the control method for the hardware appliance in connection with the URL of the website is stored with respect to each member and the identification of the particular hardware appliance is possible by the member ID in connection with the contacted website. For example, the hardware information database 180 records the member ID as the additional field.

Further, if the unique value indicating the hardware appliance and the control method are stored with respect to each member, it is desirable if hardware operation method when the web page is moved (that is, when contacting new URL) is recorded.

For example, when the web page which the user computer 50 contacts is moved and new URL is contacted, ‘auto’ method which operates the hardware appliance automatically or ‘operation after check’ method which operates the hardware appliance after asking whether to operate the hardware appliance to the user computer is recorded. For example, the hardware operation method when the web page is moved is recorded on the member database 170 as the additional field.

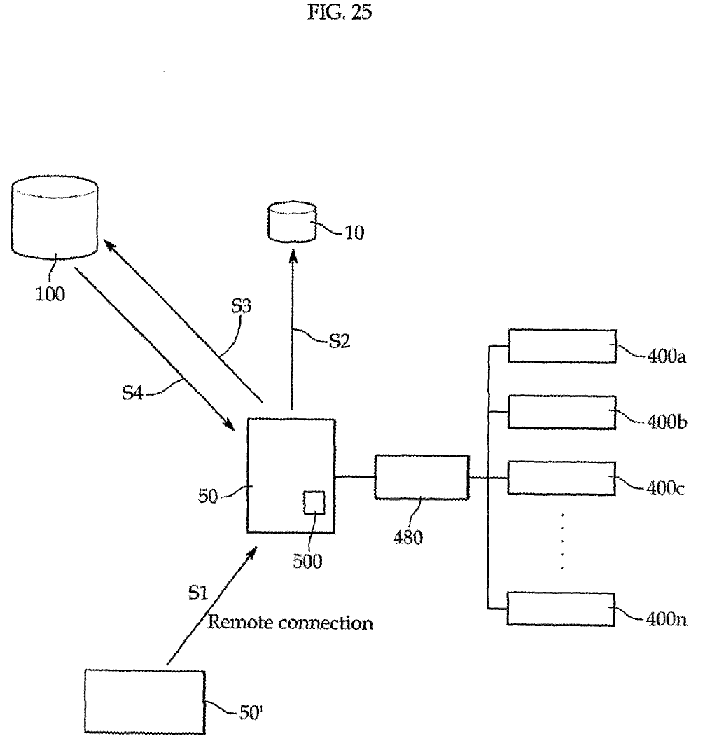

FIG. 25 shows process of the remote control or home automation to the user computer 50 according to the present invention.

Firstly, a plurality of hardware appliances 400a, 400b, 400c, . . . , 400n are provided in the user computer 50 through the hardware interface device 480. The hardware interface device 480 is a kind of hub to connect the plural hardware appliances with the user computer.

In this case, the hardware interface device 480 has a plurality of slots through which the hardware appliances are connected. Accordingly, the hardware information database 180 records the IP address and Mac address of the user computer and Mac address and slot ID of the hardware interface device 480 so that the server 100 can identify the hardware appliance connected with the user computer.

Especially, the hardware interface device 480 may have CPU for controlling the hardware appliances 400a, 400b, 400c, . . . , 400n in accordance with the control signal from the user computer. Also, the user computer 50 may have a device driver to monitor or operate the hardware interface device 480 and a management program to set up the hardware information, the control method and the hardware operation method when the web page is moved on the server 100.

It is apparent that the hardware appliances 400a, 400b, 400c, . . . , 400n can be connected to the user computer 50 by wire or wireless connection.

At this state, a remote computer 50′ makes a connection with the user computer 50 by a remote connection. (Step S1)

Next, the remote computer 50′ makes the user computer 50 contact the website 10. (Step S2)

Then, the Internet service apparatus 500 on the user computer 50 reads the URL of the website and transfers the URL to the server 100 and requests control command controlling the operation of the hardware to the server 100. (Step S3)

In this case, if the only one hardware appliance is recorded in connection with the URL, the server 100 may identify the hardware by the URL. However, if a plurality of hardware is recorded in connection with the URL, the server may request to designate the hardware.

Then, the remote computer 50′ controls the user computer 50 to designate the hardware appliance. For example, the hardware ID is inputted or if the display of the user computer 50 outputted to the remote computer 50′ shows a plurality of the hardware appliances according to the URL, the hardware appliance to be controlled is selected. At this time, the control method may be also designated.

Then, the server 100 transmits control code defining the operation of the designated hardware appliance to the Internet service apparatus 500. (Step S4) Accordingly, the user computer 50 controls the designated hardware appliance according to the control code and the hardware appliance operates.

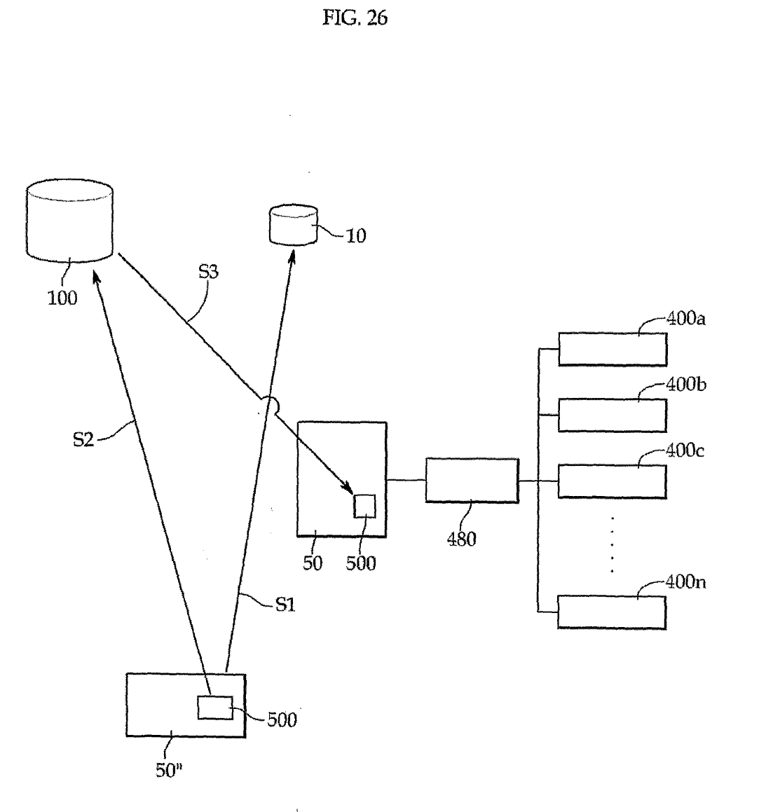

FIG. 26 shows another process of the remote control or home automation to the user computer 50 according to the present invention.

As in the case shown in FIG. 25, the user computer 50 is connected with the a plurality of hardware appliances 400a, 400b, 400c, . . . , 400n through the hardware interface device 480.

Also, a remote computer 50” has the Internet service apparatus 500.

At this state, the remote computer 50″ contacts the website 10. (Step S1)

Then, the Internet service apparatus 500 on the remote computer 50″ reads the URL of the website and transfers the URL to the server 100 and requests control command controlling the operation of the hardware appliance provided in the user computer 50 to the server 100. (Step S2)

In this case, the server 100 may request to designate the hardware and the remote computer 50″ designates the hardware appliance to be controlled connected with the user computer 50.

For example, the hardware ID according to the hardware information database 180 is inputted. In other case, if the unique value indicating the hardware provided in the user computer in connection with the URL is stored with respect to each member and the remote computer 50″ logs in the server by the member ID in connection with the user computer 50, the server 50 displays the hardware appliances in connection with the member ID and the URL.

The remote computer 50″ selects the hardware appliance to be controlled.

Then, the server 100 transmits control code defining the operation of the designated hardware appliance to the Internet service apparatus 500 on the user computer 50. (Step S3) Accordingly, the user computer 50 controls the designated hardware appliance according to the control code.

In this case, the control code may define the monitoring of the hardware appliance so that the monitoring result is transmitted to the server 100 and the server 100 outputs the monitoring result to the remote computer 50″.

As described, according to the present invention, it is possible to control the hardware appliance provided in the user computer 50 in connection with the URL of the website which the user computer contacts and the remote control or home automation in connection with the URL of the website which the user computer contacts is accomplished.

Especially, according to the present invention, communication terminal equipment which can communicate with the server or the service server and the website is sufficient as the user computer 50. It can be incorporated with or separated from the hardware interface device 480.

According to the present invention, the remote control shown with reference to FIGS. 25 and 26 includes the monitoring of the hardware appliance provided in the user computer.

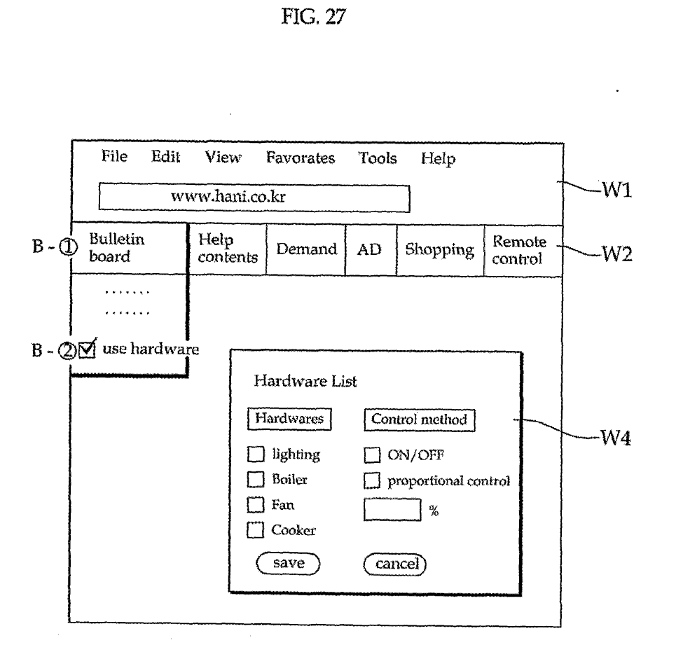

FIG. 27 shows a display on the user computer to set-up the control method to the server 100.

The user computer 50 contacts www.hani.co.kr and the web page is displayed on the user computer 50 and the toolbar W2 is shown.

When the ‘bulletin board’ is clicked (B-\textcircled{1}) on the toolbar W2, bulletin board contents are appeared. When ‘Use Hardware’ in the lower portion is checked (B-\textcircled{2}), control set-up window W4 is outputted. Accordingly, the user can set up the control method for the hardware appliance provided in the user's computer.

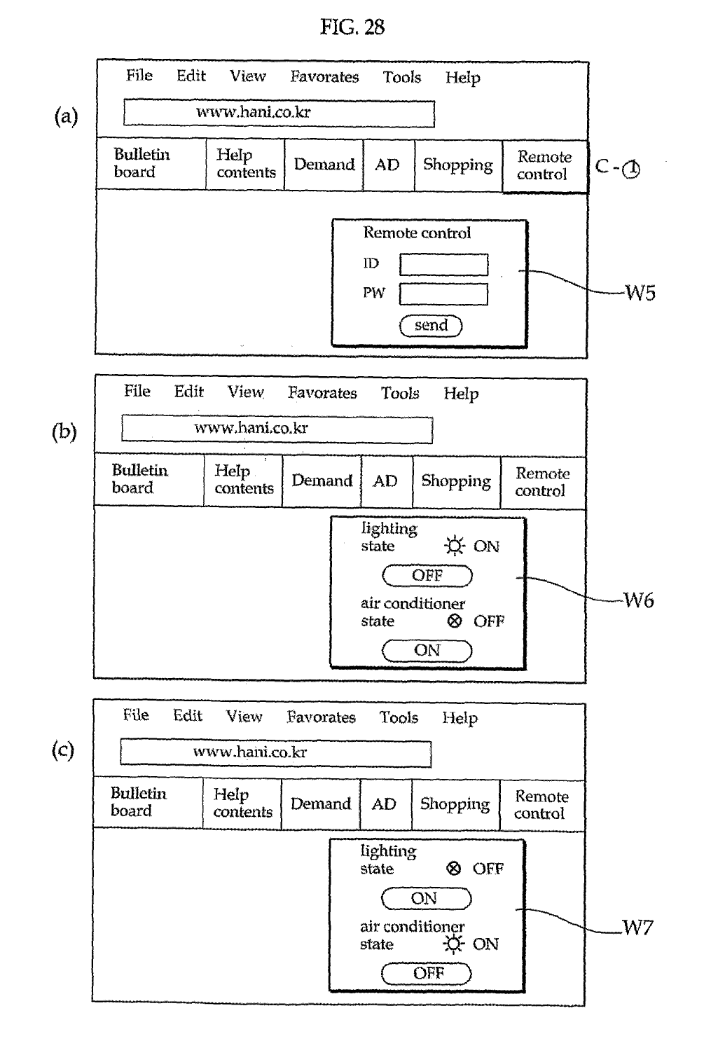

FIG. 28 shows a display when the remote control is performed according to the embodiment of the present invention.

FIG. 28(a) shows a display on the remote computer 50′ or 50″. The display on the remote computer 50′ is to show the display on the user computer 50 through a remote connection program.

At this time, ‘Remote control’ is clicked on the toolbar W2 outputted from the server 100 (C-\textcircled{1}), a window W5 to which member ID and password are inputted is outputted.

Next, if the member ID and the password are inputted to the window W5 for log-in, as shown in FIG. 28(b), the server 100 outputs the monitoring result for the hardware appliances in connection with the URL and the member ID and a window W6 to request operation command. In this view, ON or OFF buttons are displayed.

The remote computer 50′ or 50″ inputs the operation command and, accordingly, the control is made to the user computer 50 and the monitoring result is displayed as shown in FIG. 28(c).

Especially, according to the present invention, in connection with the remote control or the home automation, it is possible to use the control method set up by another. That is, if the control method for the hardware appliance is set up with respect to the respective member, it is to use another's set up for the same hardware appliance.

In this case, the hardware operation method when the web page is moved further includes ‘Use other's set up’. And if ‘Use other's set up' is selected, other user's set-up for the same hardware appliances are displayed on the remote computer 50′ or 50″. If one of them is selected, the hardware appliance operates according to the set-up.

As described above, the present invention makes it possible to control the hardware appliance provided in the user computer in connection with the web page of the website which the user computer contacts by the control of the remote computer 50′ or in connection with the web page of the website which the remote computer 50″ contacts. Accordingly, the user can easily and conveniently control the hardware appliance in the remote location by contacting the particular web pages.

Especially, the remote control is performed on the base of the position on the web page displayed by the contacted URL.

In this case, for example, it is possible to display the monitoring result of the hardware appliance provided in the user computer, set up the control method of the hardware appliance or command the control of the hardware appliance in connection with the particular position on the web page displayed by the contacted URL.

It is very useful because the user can directly recognize that the hardware appliance is related to contents on the position on the web page displayed by the contacted URL.

In this case, the hardware control field shown in FIG. 24 may be incorporated into the bulletin board database 130, the help contents database 140, the demand database 150 or the advertisement database 160. In this case, the remote control of the hardware appliances 400a, 400b, . . . , 400n may be performed in connection with the service data corresponding to the position coordinate. In other case, an independent database recoding the corresponding hardware appliance and the control method in connection with the URL of the website may be provided and, at this time, the position coordinate may be also recorded thereon.

Further, in other case, the position coordinate can be recorded corresponding to the hardware ID on the hardware information database 180.

The user computer 50 accesses to the server 100 and performs the set up of the position coordinate. In other case, the server 100 provides set-up interface on the web page the user computer contacts and the user performs the set-up following the set-up interface.

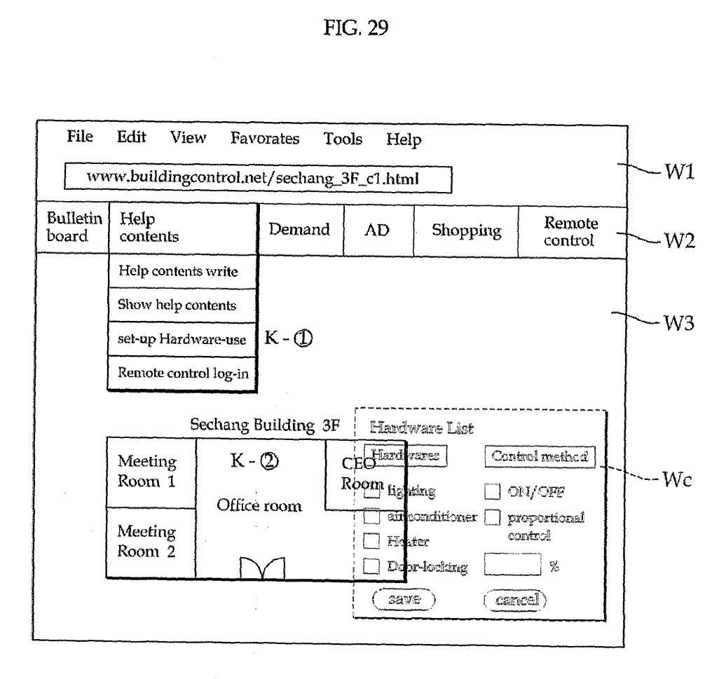

FIG. 29 shows that the hardware control method is set up in connection with the position in the remote control or home automation. Firstly, the URL of the website the user computer 50 contacts is www.buildingcontrol.net/sechang_{—}3F_C1.html. The web page according to the URL is displayed on the user computer 50 and the server 100 outputs the toolbar W2 as the service interface.

Among the items appeared when the help contents is clicked on the toolbar W2, the ‘Hardware set-up’ is clicked (K-\textcircled{1}). Then, the position is designated by placing the mouse on the position (K-\textcircled{2}) on the web page W3 and clicking the mouse. In this case, the user can log in firstly so that the set-up value is stored with respect to the user.

Then, window We on which the control method for the hardware appliance is set up is outputted in connection with the designated position. Accordingly, the hardware appliance and the corresponding control method are set up.

Then, the server 100 stores the control method for the hardware appliance in connection with the position (K-\textcircled{2}) of the URL.

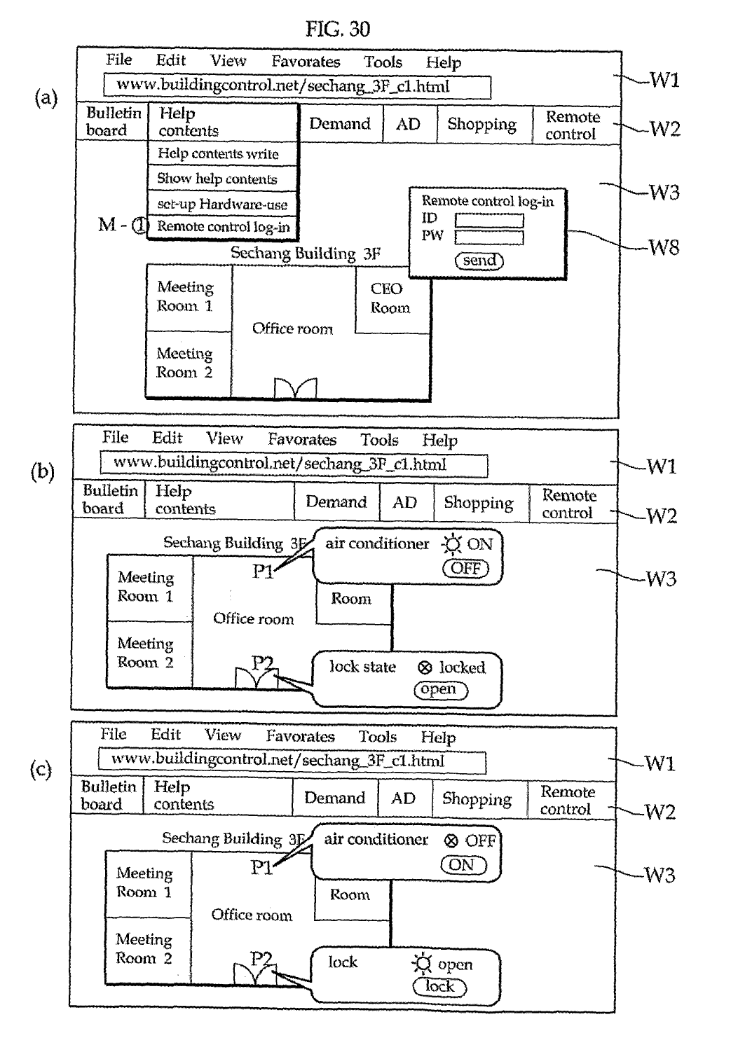

FIG. 30 shows a display when the remote control is performed in connection with the position.

Firstly, as shown in FIG. 30(a), the ‘remote control log-in’ (M-\textcircled{1}) is clicked among the help contents items on the toolbar W2 outputted by the server 100. Then a log-in window W8 is outputted and the user logs in.

Then, as shown in FIG. 30(b), the monitoring result for the hardware appliances and interface for inputting the control command are displayed on the particular positions P1 and P2 on the web page W3 displayed on the user computer.

Accordingly, the user can command the control for the hardware appliances, if necessary.

FIG. 30(c) shows that the control is performed by the control command and the monitoring result is outputted.

In FIG. 30, a location map for three floor of a particular building is displayed by the website which the user computer contacts. At this time, the monitoring result for air conditioner and lock equipped at the office in connection with the particular positions P1 and P2 is displayed and the air conditioner and the lock can be controlled by the contacted webpage of www.buildingcontrol.net/sechang_{—}3F_C1.html.

As described, the remote control or the home automation is performed on the base of the position on the web page displayed by the contacted URL. Accordingly, the user accesses to the web page at the remote location and directly recognize what the hardware appliance is and easily control the hardware appliance in connection with the position.

### INDUSTRIAL APPLICABILITY

As described, the present invention shows the Internet service system which provides a variety of Internet services in connection with the URL which the user computer contacts on the particular position on the web page displayed on the user computer and the method for the same.

Therefore, it is understood that the purpose of the present invention is accomplished.

The present invention is described with reference to the specific embodiments, but the invention is not limited thereto. Only the following claims will determine the scope of the invention.

1. A method for providing Internet service in connection with URL which a user computer, which has a web browser, contacts where a server is connected to a plurality of the user computers via Internet and the server or a service server managed by the server has service data storage means which stores service data according to the Internet service in connection with the URL which the user computer contacts and position coordinate on web page according to the URL displayed on the user computer, comprising:
(a) website address transferring step wherein the user computer transfers the URL of the website to the server when the user computer contacts the website;
(b) website address recognition step wherein the server or the service server managed by the server reads the transferred URL;
(c) service interface output step wherein the server or the service server outputs service interface according to the Internet service on the web page of the website displayed on the user computer; and
(d) service data output step wherein the server or the service server outputs the service data on the position coordinate on the web page of the website displayed on the user computer in accordance with the service interface.

2. The method for providing Internet service in connection with URL which a user computer contacts as claimed in claim 1, further comprising:
(a) service data transferring step wherein the user computer transfers the service data with the position coordinate to the server or to the service server;
(b) service data storage step wherein the server or the service server stores the transferred service data on the service data storage means in connection with the position coordinate.

3. The method for providing Internet service in connection with URL which a user computer contacts as claimed in claim 2, wherein the service server is the website which the user computer contacts.

4. The method for providing Internet service in connection with URL which a user computer contacts as claimed in claim 2, wherein the method further comprises output position transferring step wherein the user computer transfers a particular position coordinate on the web page of the website displayed on the user computer to the server or the service server and the service data output step includes designated position output step wherein the server or the service server outputs the service data stored on the service data storage means in connection with the position coordinate transferred according to the output position transferring step on the position coordinate on the web page of the website displayed on the user computer.

5. The method for providing Internet service in connection with URL which a user computer contacts as claimed in claim 4, wherein the output position transferring step is to transfer the position coordinate pointed by a pointing device on the web page of the website displayed on the user computer.

6. The method for providing Internet service in connection with URL which a user computer contacts as claimed in claim 1 wherein the service data output step includes:
(a) service data presence step according to position wherein the server or the service sever displays the presence of the service data on the position coordinate on which the service data is present on the web page of the website displayed on the user computer; and
(b) service data output step according to designated position step wherein when position on which the presence of the service data is displayed is designated by the user computer, the server or the service server outputs the service data stored in connection with the designated position coordinate on the position coordinate on the web page of the website displayed on the user computer.

7. The method for providing Internet service in connection with URL which a user computer contacts as claimed in claim 6 wherein the service data presence step according to position is to display the presence of the service data by figure.

8. The method for providing Internet service in connection with URL which a user computer contacts as claimed in claim 7 wherein the service data presence step according to position is to show the number of the service data at the figure.

9. (canceled)

10. (canceled)

11. The method for providing Internet service in connection with URL which a user computer contacts as claimed in claim 1, wherein
(a) the method further comprises:
(a1) service data input request step wherein the user computer let the server or the service server know that the service data is inputted in connection with designated position coordinate; and
(a2) input means output step wherein the server or the service server outputs input means to the user computer according to the service data input request step; and
(b) the service data transferring step is to transfer the data inputted to the input means to the server or the service server.

12. The method for providing Internet service in connection with URL which a user computer contacts as claimed in claim 11 wherein the input means output step is to output input form to the user computer.

13. The method for providing Internet service in connection with URL which a user computer contacts as claimed in claim 1 wherein the Internet service is a bulletin board service and the service data storage means stores bulletin board contents.

14. The method for providing Internet service in connection with URL which a user computer contacts as claimed in claim 1 wherein the Internet service is a help contents service which provides help contents for using the website which the user computer contacts and the service data storage means stores help contents.

15. The method for providing Internet service in connection with URL which a user computer contacts as claimed in claim 2 wherein the Internet service is a demand service which demands or suggests improvement in connection with the website which the user computer contacts and the service data storage means stores demanded contents.

16. The method for providing Internet service in connection with URL which a user computer contacts as claimed in claim 15 wherein output of the demanded contents according to the service data output step is made to a manager's computer of the server or a manager's computer of the website which the user computer contacts.

17. The method for providing Internet service in connection with URL which a user computer contacts as claimed in claim 1 wherein the Internet service is an electronic commerce service and the service data storage means stores information related to the electronic commerce.

18. The method for providing Internet service in connection with URL which a user computer contacts as claimed in claim 1 wherein the Internet service is an advertisement service and the service data storage means stores advertisement information.

19. The method for providing Internet service in connection with URL which a user computer contacts as claimed in claim 1 wherein the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

20. The method for providing Internet service in connection with URL which a user computer contacts as claimed in claim 1 wherein the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

21. (canceled)

22. (canceled)

23. A method for providing Internet service in connection with URL which a user computer, which has a web browser, contacts where a server is connected to a plurality of the user computers via Internet, comprising:
(a) website address transferring step wherein the user computer transfers the URL of the website to the server when the user computer contacts the website;
(b) website address recognition step wherein the server or the service server managed by the server reads the transferred URL;
(c) service interface output step wherein the server or the service server outputs service interface according to the Internet service on the web page of the website displayed on the user computer;
(d) output position transferring step wherein the user computer transfers a particular position coordinate on the web page of the website displayed on the user computer to the server or the service server;
(e) designated position output step wherein the server or the service server outputs the service data stored on the service data storage means in connection with the position coordinate transferred according to the output position transferring step on the position coordinate on the web page of the website displayed on the user computer.

24. A method for providing Internet service in connection with URL which a user computer, which has a web browser, contacts where a server is connected to a plurality of the user computers via Internet, comprising:
(a) website address transferring step wherein the user computer transfers the URL of the website to the server when the user computer contacts the website;
(b) list of user computers contacting the same web site output step wherein the server or the service server managed by the server reads the transferred URL and outputs list of the user computers which contact the website to the user computers;
(c) Internet service provision between user computers step wherein when the user computer selects one from the listed user computers, the server or the service server relays the user computer and the selected user computer and provides the Internet service between them.

25. The method for providing Internet service in connection with URL which a user computer as claimed in claim 24 wherein the Internet service between the user computers is one among chatting, game and message transmission.

26. The method for providing Internet service in connection with URL which a user computer as claimed in claim 24 wherein the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

27. The method for providing Internet service in connection with URL which a user computer as claimed in claim 24 wherein the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

28. A server system providing Internet service in connection with URL which a user computer, which has a web browser, contacts where a server is connected to a plurality of the user computers via Internet, comprising:
(a) service data storage means which stores service data according to the Internet service in connection with the URL which the user computer contacts and position coordinate on web page according to the URL displayed on the user computer;
(b) website address recognition means which reads the URL of the website transferred from the user computer when the user computer contacts the website;
(c) service interface output means which outputs service interface according to the Internet service on the web page of the website displayed on the user computer;
(d) service data output means which outputs the service data on the position coordinate on the web page of the website displayed on the user computer in accordance with the service interface.

29. A server system providing Internet service in connection with URL which a user computer, which has a web browser, contacts where a server is connected to a plurality of the user computers via Internet, comprising:
(a) website address recognition means which reads the URL of the website transferred from the user computer when the user computer contacts the website;
(b) service interface output means which outputs service interface according to the Internet service on the web page of the website displayed on the user computer;
(c) designated position output means which outputs the service data on an output position coordinate on the web page of the website displayed on the user computer in response to the user computer's designation of the output position coordinate.

30. A server system providing Internet service in connection with URL which a user computer, which has a web browser, contacts where a server is connected to a plurality of the user computers via Internet, comprising:
(a) website address recognition means which reads the URL of the website transferred from the user computer when the user computer contacts the website;
(b) list of user computers contacting the same web site output means which outputs list of the user computers which contact the website according to the URL;
(c) Internet service provision between user computers means which relays the user computer and the selected user computer and provides the Internet service between them when the user computer selects one from the listed user computers.

31. The server system providing Internet service in connection with URL which a user computer, which has a web browser, contacts where a server is connected to a plurality of the user computers via Internet claimed in claim 30 wherein the Internet service between the user computers is one among chatting, game and message transmission.

32. A method for providing Internet service in connection with URL which a user computer, which has a web browser, contacts where a server is connected to a plurality of the user computers via Internet; the server or a service server managed by the server stores position coordinate at which the Internet service is provided on the web page of the website displayed on the user computer in connection with the URL which the user computer contacts; and the user computer has an Internet service apparatus which reads the URL of the website which the user computer contacts and transfers the URL to the server, comprising:
(a) website address transferring step wherein the Internet service apparatus reads and transfers the URL of the website to the server when the user computer contacts the website; and
(b) Internet service provision step wherein the server or the service server reads the URL and provides the Internet service at the position coordinate corresponding to the URL on the web page of the website displayed on the user computer.

33. The method for providing Internet service in connection with URL which a user computer contacts as claimed in claim 32 wherein the website which the user computer contacts has a web page file containing a call code to make the Internet service apparatus downloaded from the server or the service server.

34. The method for providing Internet service in connection with URL which a user computer contacts as claimed in claim 33 wherein the call code is displayed on the position at which the Internet service is provided on the web page of the website displayed on the user computer.

35. The method for providing Internet service in connection with URL which a user computer contacts as claimed in claim 32 wherein the server or the service server stores key words in connection with the URL and the method further comprising:
(a) search form output step wherein the server or the service server outputs search form to which the key word is inputted on the web page of the website displayed on the user computer;
(b) search result output step wherein the server or the service server compares the inputted keyword through the search form with the key word stored in connection with the URL and outputs the result to the user computer.

36. The method for providing Internet service in connection with URL which a user computer contacts as claimed in claim 32 wherein the server or the service server stores advertisement data and the method further comprising advertisement step wherein the server or the service server outputs the advertisement data on the web page of the website displayed on the user computer.

37. The method for providing Internet service in connection with URL which a user computer contacts as claimed in claim 32 wherein the web page of the website which the user computer contacts includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

38. The method for providing Internet service in connection with URL which a user computer contacts as claimed in claim 32 wherein the service data which the server or the service server outputs to the user computer includes a link code containing URL of the linked web page and position coordinate on the linked web page or identifier to those information so that the web page is moved to the linked web page and mark is made on the position coordinate on the linked web page or the Internet service is provided at the position coordinate on the linked web page.

39. A method for controlling hardware appliance provided in a user computer in connection with URL which the user computer which has a web browser contacts where a server is connected to a plurality of the user computers via Internet and the server or a service server managed by the server stores a unique value indicating the hardware appliance provided in the user computer in connection with the URL which the user computer contacts, comprising:
(a) website address transferring step wherein the user computer transfers the URL of the website to the server when the user computer contacts the website;
(b) control command request step wherein the user computer request a control command to control the hardware appliance to the server or the service server; and
(c) control command step wherein the server or the service server transfers a control code according to the URL to the user computer.

40. The method for controlling hardware appliance provided in a user computer in connection with URL which the user computer contacts as claimed in claim 39 wherein the unique value indicating the hardware appliance provided in the user computer is IP address, Mac address and port number, to which the hardware appliance is connected, of the user computer.

41. The method for controlling hardware appliance provided in a user computer in connection with URL which the user computer contacts as claimed in claim 39 wherein the unique value indicating the hardware appliance provided in the user computer in connection with the URL is recorded with respect to each member of the user so that the hardware appliance is controlled in connection with the URL the user computer contacts according to the each member.

42. A method performed by an Internet service apparatus provided in the user computer for providing Internet service in connection with URL which a user computer having a web browser contacts, the Internet service apparatus storing service data in connection with the URL and position coordinate on the web page of the URL displayed on the user computer, comprising:
(a) website address recognition step recognizing the URL of the website when the user computer contacts the website;
(b) service interface output step outputting service interface according to the Internet service on the web page of the website displayed on the user computer; and
(c) service data output step outputting the service data on the corresponding position coordinate on the web page of the website displayed on the user computer in accordance with the service interface.

43. The method performed by an Internet service apparatus provided in the user computer for providing Internet service in connection with URL which a user computer having a web browser contacts as claimed in claim 42 wherein the website is a specified website and the Internet service apparatus is downloaded from the specified website and installed on the user computer.

44. The method performed by an Internet service apparatus provided in the user computer for providing Internet service in connection with URL which a user computer having a web browser contacts as claimed in claim 42 wherein the Internet service apparatus is installed on a portable memory device and executed by auto run when the portable memory device is connected to the user computer.

45. The method performed by an Internet service apparatus provided in the user computer for providing Internet service in connection with URL which a user computer having a web browser contacts as claimed in claim 42 wherein the Internet service provided by the Internet service apparatus is a help contents service which outputs help contents for using the website on the corresponding position on the web page of the website which the user computer contacts.

46. The method performed by an Internet service apparatus provided in the user computer for providing Internet service in connection with URL which a user computer having a web browser contacts as claimed in claim 42 wherein the Internet service provided by the Internet service apparatus is an advertisement service which outputs the advertisement data on the corresponding position on the web page of the website which the user computer contacts.

47. A method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising:
(a) remote connection to the user computer step wherein a remote computer connects to the user computer by remote connection;
(b) website address transferring step wherein the user computer transfers the URL of the website to the server when the user computer contacts the website by the control of the remote computer;
(c) control command request step wherein the user computer request a control command to control the designated hardware appliance to the server or the service server by the control of the remote computer; and
(d) control command step wherein the server or the service server transfers a control code to the user computer.

48. The method for controlling hardware appliance provided in a user computer at a remote location in connection with URL which the user computer having a web browser contacts as claimed in claim 47 wherein the control command request step includes designation of hardware appliance step wherein the user computer designates the hardware appliance provided therein to be controlled in response to request of the server or the service server to designate the hardware appliance.

49. The method for controlling hardware appliance provided in a user computer at a remote location in connection with URL which the user computer having a web browser contacts as claimed in claim 47 wherein the unique value indicating the hardware appliance provided in the user computer includes IP address, Mac address of the user computer and sub-value according to sub-connection to the hardware appliance.

50. The method for controlling hardware appliance provided in a user computer at a remote location in connection with URL which the user computer contacts as claimed in claim 49 wherein the sub-value according to sub-connection to the hardware appliance is Mac address of a hardware interface device and slot ID in the hardware interface device.

51. The method for controlling hardware appliance provided in a user computer at a remote location in connection with URL which the user computer having a web browser contacts as claimed in claim 47 wherein the unique value indicating the hardware appliance provided in the user computer in connection with the URL is recorded with respect to each member of the user so that the hardware appliance is controlled in connection with the URL the user computer contacts according to the each member.

52. The method for controlling hardware appliance provided in a user computer at a remote location in connection with URL which the user computer having a web browser contacts as claimed in claim 47 wherein the user computer is communication terminal equipment which can communicate with the server or the service server and the website through Internet.

53. The method for controlling hardware appliance provided in a user computer at a remote location in connection with URL which the user computer having a web browser contacts as claimed in claim 47 wherein the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

54. The method for controlling hardware appliance provided in a user computer at a remote location in connection with URL which the user computer having a web browser contacts as claimed in claim 53 wherein the hardware control interface is directed to set-up of the hardware appliance in connection with the URL, display of monitoring result of the hardware appliance and control command for the hardware appliance.

55. A method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising:
(a) website address transferring step wherein a remote computer at the remote location transfers the URL of the website to the server when the remote computer contacts the website;
(b) control command request step wherein the remote computer request a control command to control the designated hardware appliance provided in the user computer to the server or the service server; and
(c) control command step wherein the server or the service server transfers a control code to the user computer.

56. The method for controlling hardware appliance provided in a user computer at a remote location in connection with URL which the user computer having a web browser contacts as claimed in claim 55 wherein the control command request step includes designation of hardware appliance step wherein the remote computer designates the hardware appliance provided in the user computer to be controlled in response to request of the server or the service server to designate the hardware appliance.

57. The method for controlling hardware appliance provided in a user computer at a remote location in connection with URL which the user computer having a web browser contacts as claimed in claim 55 wherein the unique value indicating the hardware appliance provided in the user computer in connection with the URL is recorded with respect to each member of the user so that the hardware appliance is controlled in connection with the URL the remote computer contacts according to the each member.

58. The method for controlling hardware appliance provided in a user computer at a remote location in connection with URL which the user computer having a web browser contacts as claimed in claim 55 wherein the user computer is communication terminal equipment which can communicate with the server or the service server and the website through Internet.

59. The method for controlling hardware appliance provided in a user computer at a remote location in connection with URL which the user computer having a web browser contacts as claimed in claim 57 wherein each control method of the hardware appliance is set up with respect to the respective member and if the remote computer selects another member's set up for the control method of the same hardware appliance, the server or the service server controls the user computer having the same hardware appliance according to the another's set up.

60. The method for controlling hardware appliance provided in a user computer at a remote location in connection with URL which the user computer having a web browser contacts as claimed in claim 55 wherein the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

61. The method for controlling hardware appliance provided in a user computer at a remote location in connection with URL which the user computer having a web browser contacts as claimed in claim 55 wherein the hardware control interface is directed to set-up of the hardware appliance in connection with the URL, display of monitoring result of the hardware appliance and control command for the hardware appliance.

62. A method for controlling hardware appliance provided in a user computer in connection with URL which the user computer which has a web browser contacts where a server is connected to a plurality of the user computers via Internet and the server or a service server managed by the server stores a unique value indicating the hardware appliance provided in the user computer in connection with the URL which the user computer contacts, comprising:
(a) website address recognition step wherein the server recognizes the URL of the website which the user computer contacts by the URL transferred from the user computer when the user computer contacts the website; and
(b) control command step wherein the server or the service server transfers a control code to control the hardware appliance provided therein to the user computer in response to the user computer's request for a control command to control the hardware appliance.

63. A method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising:
(a) website address recognition step wherein the server recognizes the URL of the website which the user computer contacts by the URL transferred from the user computer when the user computer contacts the website by the control of the remote computer; and
(b) control command step wherein the server or the service server transfers a control code to the user computer to control the hardware appliance provided therein in response to the user computer's request for a control command to control the designated hardware appliance by the control of the remote computer.

64. A method for controlling hardware appliance provided in a user computer at a remote location in connection with URL which the user computer having a web browser contacts as claimed in claim 63 wherein the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.

65. A method for controlling hardware appliance provided in a user computer at a remote location in connection with URL which the user computer having a web browser contacts where a server is connected to a plurality of the user computers via Internet and the server or a service server managed by the server stores a unique value indicating the hardware appliance provided in the user computer in connection with the URL which the user computer contacts, comprising:
(a) website address recognition step wherein the server recognize URL of the website which a remote computer contacts by the URL transferred from the remote computer when the remote computer contacts the website; and
(b) control command step wherein the server or the service server transfers a control code to the user computer to control the hardware appliance provided therein in response to the remote computer's request for a control command to control the designated hardware appliance.

66. The method for controlling hardware appliance provided in a user computer at a remote location in connection with URL which the user computer having a web browser contacts as claimed in claim 65 wherein the server or the service server stores the unique value in connection with position on the web page of the website displayed on the user computer in connection with the URL and the method further comprises hardware appliance control interface output step wherein the server or the service server outputs hardware appliance control interface on the corresponding position on the web page of the URL displayed on the user computer.
